(19) United States
(12) Patent Application Publication
(10) Pub. No.: US 2025/0130316 A1
(43) Pub. Date: Apr. 24, 2025

(54) RETURN SURFACES IN LIDAR SYSTEMS

(71) Applicant: SiLC Technologies, Inc., Monrovia, CA (US)

(72) Inventors: Mehdi Asghari, La Canada Flintridge, CA (US); Nirmal Chindhu Warke, Saratoga, CA (US)

(21) Appl. No.: 18/383,037

(22) Filed: Oct. 23, 2023

(51) Int. Cl. G01S 7/481; G01S 17/89; G01S 17/931

(52) U.S. Cl. CPC G01S 7/4817; G01S 17/89; G01S 17/931

(57) ABSTRACT

A LIDAR system has a semiconductor chip configured to concurrently output multiple LIDAR output signals. The semiconductor chip includes alternate waveguides. Each of the alternate waveguides carries a different outgoing LIDAR signal. Each of the LIDAR output signals includes light from a different one of the LIDAR output signals. The semiconductor chip includes a reflecting surface that receives incoming LIDAR signals that each includes light from a different one of the LIDAR output signals. The semiconductor chip also includes comparative waveguides. Each of the comparative waveguides receives a comparative signal from the reflecting surface. Each of the comparative signals includes light from a different one of the incoming LIDAR signals.

### FIELD

The invention relates to imaging. In particular, the invention relates to LIDAR systems.

### BACKGROUND

There is an increasing commercial demand for LIDAR systems that can be deployed in a variety of applications including ADAS (Advanced Driver Assistance Systems) and AR (Augmented Reality). LIDAR systems typically output a system output signal that is reflected by an object located outside of the LIDAR system. At least a portion of the reflected light signal returns to the LIDAR system in a system return signal. The LIDAR system directs the received light signal to a light sensor that converts the light signal to an electrical signal. Electronics can use the light sensor output to quantify LIDAR data that can indicate a variety of data such as the radial velocity and/or distance between the object and the LIDAR system.

The LIDAR systems often use a circulator to separate the reflected light signal from the system output signal. However, these circulators are often expensive and increase the complexity of the LIDAR system.

### SUMMARY

A LIDAR system has a semiconductor chip configured to concurrently output multiple LIDAR output signals. The semiconductor chip includes alternate waveguides. Each of the alternate waveguides carries a different outgoing LIDAR signal. Each of the LIDAR output signals includes light from a different one of the LIDAR output signals. The semiconductor chip includes a reflecting surface that receives incoming LIDAR signals that each includes light from a different one of the LIDAR output signals. The semiconductor chip also includes comparative waveguides. Each of the comparative waveguides receives a comparative signal from the reflecting surface. Each of the comparative signals includes light from a different one of the incoming LIDAR signals.

A LIDAR system has a semiconductor chip configured to concurrently output multiple LIDAR output signals. The semiconductor chip includes alternate waveguides. Each of the alternate waveguides carries a different outgoing LIDAR signal. Each of the outgoing LIDAR signals includes light from a different one of the LIDAR output signals. The semiconductor chip includes a reflecting surface that receives and reflects the LIDAR output signals from the alternate waveguides. The reflecting surface is configured such that the LIDAR output signals travel away from the semiconductor chip in different directions.

A LIDAR system has a semiconductor chip that includes a signal director configured to receive incoming LIDAR signals. Each of the incoming LIDAR signals includes light that was reflected by an object located outside of the LIDAR system. The semiconductor chip includes a free space region and the signal director is configured to direct the incoming LIDAR signals through the free space region such that each of the incoming LIDAR signals separates into multiple sub-incoming LIDAR signals. The sub-incoming LIDAR signals separated from the same incoming LIDAR signal have different selections of polarization states. The semiconductor chip also includes multiple comparative waveguides. Each of the comparative waveguides receives a different one of the sub-incoming LIDAR signals.

A LIDAR system has a semiconductor chip that includes a reflecting surface. The LIDAR system also includes a beam shaper located off the LIDAR chip. The reflecting surface and the beam shaper exchange light signals with the light signal being transmitted through the beam shaper and being reflected by the reflecting surface. The reflecting surface is configured to collimate the light signal in a first plane that is parallel to a plane of the LIDAR chip without substantially collimating the light signal in a second plane that is orthogonal to the first plane and the beam shaper is configured to collimate the light signal in the second plane without substantially collimating the light signal in the first plane. Additionally, or alternately, the beam shaper can be configured to focus the light signal in the second plane without substantially focusing the light signal in the first plane and the return surface can be configured to focus the light signal in the in the first plane without substantially focusing the light signal in the second plane.

### DESCRIPTION OF THE FIGURES

FIG. 1A is a schematic of a LIDAR system that includes a LIDAR chip with a photonic circuit.

FIG. 1B is a schematic of another example of a LIDAR system that includes a LIDAR chip with a photonic circuit.

FIG. 2 is a schematic of a LIDAR system that includes the LIDAR chip of FIG. 1A.

FIG. 3 is a schematic of an example of a suitable light source.

FIG. 4A through FIG. 4F illustrate an example of a suitable output component for use with the LIDAR chip of FIG. 1A and/or FIG. 1B. FIG. 4A is schematic of a topview of the output component.

FIG. 4B is a close-up of the portion of the output component encircled by the dashed line labeled B in FIG. 4A.

FIG. 4C is a cross section of the output component taken along the line labeled C in FIG. 4B.

FIG. 4D is a cross section of the output component taken along the line labeled D in FIG. 4B.

FIG. 4E is a cross section of the output component taken along the line labeled E in FIG. 4A.

FIG. 4F is a cross section of the output component taken along the line labeled F in FIG. 4A.

FIG. 4G is an alternate cross section of the output component taken along the line labeled E in FIG. 4A.

FIG. 5A through FIG. 5B illustrate the output component of FIG. 4A through FIG. 4G modified to include an optical grating as a signal director. FIG. 5A is a topview of the output component.

FIG. 5B is an expanded view of a portion of the signal director shown in FIG. 3A.

FIG. 6A through FIG. 6F illustrate an example of a suitable input component.

FIG. 6A is schematic of a topview of an example of an input component.

FIG. 6B is a close-up of the portion of the input component encircled by the dashed line labeled B in FIG. 6A.

FIG. 6C is a cross section of the input component taken along the line labeled D in FIG. 6B.

FIG. 6D is a cross section of the input component taken along the line labeled E in FIG. 6B.

FIG. 6E is a cross section of the input component taken along the line labeled F in FIG. 6A.

FIG. 6F is a cross section of the input component taken along the line labeled G in FIG. 6A.

FIG. 6G is a cross section of the input component taken along the line labeled F in FIG. 6A where a layer of reflective material is in contact with a return surface.

FIG. 6H is a closeup of a portion of the return component of FIG. 6A.

FIG. 7A is schematic of a topview of an example of an input component.

FIG. 7B is a close-up of a portion of a signal director included in the input component of FIG. 7A.

FIG. 7C is a close-up of the portion of the input component encircled by the dashed line labeled B in FIG. 7A.

FIG. 8A is schematic of a topview of an example of an input component.

FIG. 8B is a cross section through a free space region between a return surface and a comparative waveguide.

FIG. 8C is a cross section through a free space region between a return surface and a comparative waveguide.

FIG. 9A is a cross section of a LIDAR chip and a beam shaper that illustrates the interface between the beam shaper and a return surface on the LIDAR chip.

FIG. 9B is a perspective view of an example of a cylindrical beam shaper.

FIG. 10A through FIG. 10B illustrates an example of a light signal processor.

FIG. 10A is a schematic of an example of a suitable optical-to-electrical assembly for use in the light signal processor.

FIG. 10B provides a schematic of the relationship between electronics and the optical-to-electrical assembly of FIG. 10A.

FIG. 10C illustrates an example of the frequency versus time pattern for a system output signal transmitted from the imaging system.

FIG. 10D illustrates an example of the frequency versus time pattern for a system output signal transmitted from the imaging system.

### DESCRIPTION

A LIDAR system can be a bistatic LIDAR system where the outgoing pathway that light travels through the LIDAR system before being transmitted from the LIDAR system is separate from the incoming pathway through the LIDAR system that is traveled by light that returns to the LIDAR system after being reflected by an object located external to the LIDAR system. Since bistatic systems do not use circulators, the expense associated with circulators is removed from the LIDAR system.

A bistatic LIDAR system is configured to transmit system output signals that include light that has traveled the outgoing pathway through the LIDAR system. The LIDAR system can include a semiconductor chip that has at least a portion of the outgoing pathway and at least a portion of the incoming pathway. The portion of the outgoing pathway on the LIDAR chip can include an optical grating that has demultiplexing functionality and the portion of the incoming pathway on the LIDAR chip can include a second optical grating that has multiplexing functionality. The demultiplexing functionality of the optical grating on the outgoing pathway allows the direction that the system output signals travel away from the LIDAR system to be tuned by changing the wavelength of light transmitted by the LIDAR system. Accordingly, the use of the optical grating can provide a solid-state mechanism for increasing the resolution and/or field of view of the LIDAR system. Additionally, the increase in resolution can be achieved without an increase in the number of alternate waveguides. Accordingly, the increased resolution can be achieved without substantial increases in the complexity and/or area of the LIDAR chip.

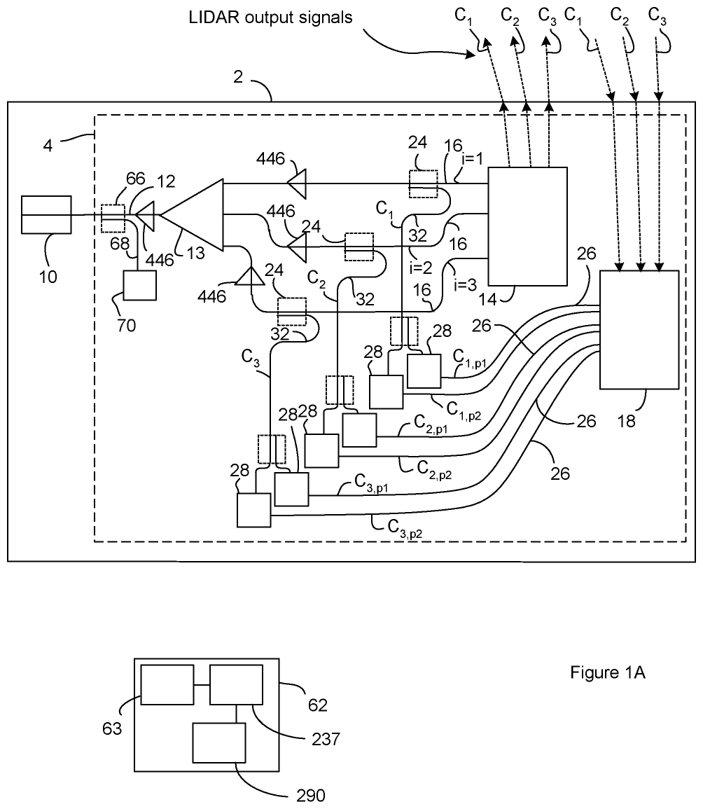

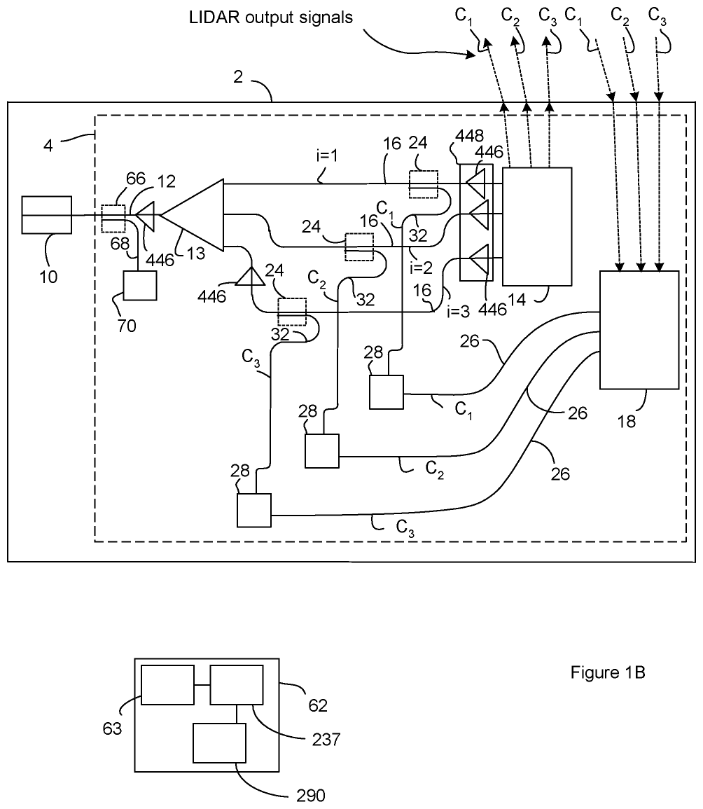

FIG. 1A is a schematic of a portion of a LIDAR system that includes a LIDAR chip. FIG. 1A includes a topview of a portion of the LIDAR chip 2. The LIDAR chip includes a light source 10 and electronics 62. The light source 10 outputs an outbound LIDAR signal that carries one of M different wavelength channels. There are M wavelength channels and each of the wavelength channels is associated with a wavelength channel index m where m has a value from 1 to M where M can be as low as 1 or greater than 1. When M is greater than 1, each of the M wavelength channels is at a different wavelength. When M is greater than 1, the electronics 62 can operate the light source 10 so as to select which of the M different wavelength channels is carried by the outbound LIDAR signal and can switch the selection of the M different wavelength channels that are carried by the outbound LIDAR signal. In some instances, the electronics 62 operate the light source 10 such that the outbound LIDAR signal carries one of the wavelength channels. For instance, the electronics 62 can operate the light source 10 such that the light source 10 outbound LIDAR signal carries a different one of the wavelength channels in series. Suitable values for M include, but are not limited to, values greater than or equal to 1, 4, 8, or 16 and less than 32, 64, or 128. In some instances, the separation between adjacent wavelength channels is greater than 0.4 nm, 0.8 nm, or 1.2 nm and/or less than 5 nm, 10 nm, or 20 nm. In some instances, the wavelengths of the different wavelength channels are periodically spaced. When M has a value of 1, the light source 10 outputs an outbound LIDAR signal that carries one wavelength channel and the electronics 62 need not switch wavelength channel carried by the outbound LIDAR signal.

The LIDAR chip can be a semiconductor chip that includes a photonic integrated circuit with a utility waveguide 12. The utility waveguide 12 receives the outbound LIDAR signal from the light source 10. The utility waveguide 12 carries the outbound LIDAR signal to a signal splitter 13 that directs the outbound LIDAR signal to multiple different alternate waveguides 16 such that each of the alternate waveguides concurrently receives a different portion of the outbound LIDAR signal. The portion of the outbound LIDAR signal received on an alternate waveguide can serve as an outgoing LIDAR signal. The outgoing LIDAR signals on different alternate waveguides carry the wavelength channel that was carried by the outbound LIDAR signal. The signal splitter 13 can be a wavelength independent signal splitter including, but not limited to, cascaded Y-junctions, cascaded MMI splitters, and a star coupler.

Each of the alternate waveguides 16 is associated with a waveguide index i with a value from i=1 to i=I. Light signals that carry light from one of the alternate waveguides 16 can be classified as being associated with the alternate waveguide 16 from which the light in the light signal originated. For instance, an outgoing LIDAR signal associated with waveguided index i=2 carries light output from and/or guided by the alternate waveguide 16 associated with index i=2.

Each of the alternate waveguides 16 guides the outgoing LIDAR signal received by that alternate waveguide 16 to an output component 14. The output component 14 can be configured such that outgoing LIDAR signals traveling through the output component 14 exit the chip and serve as a LIDAR output signal that is output from the LIDAR chip. For instance, in some instances, each of the outgoing LIDAR signals can travel along a different one of multiple different first pathways that each extends from one of the alternate waveguides 16, through the output component 14, and to an edge of the LIDAR chip.

FIG. 1A illustrates three different outgoing LIDAR signals and the resulting LIDAR output signals that are each associated with a different one of the alternate waveguides 16. For instance, the LIDAR output signals are labeled Cᵢ where i represents the waveguide index for the alternate waveguide 16 that guided light included in the outgoing LIDAR signal labeled Cᵢ. The LIDAR output signals can be concurrently output from the LIDAR chip and can carry the same wavelength channel. As shown in FIG. 1A, the output component 14 can be configured such that different LIDAR output signals travel away from the LIDAR chip in different directions.

The LIDAR system can transmit system output signals. The system output signals can be concurrently output from the LIDAR system and can carry the same wavelength channel. Accordingly, a system output signal and a LIDAR output signal that include light from the same alternate waveguide are associated with the same alternate waveguide and accordingly with the same waveguide index. The system output signals travel away from the chip and may be reflected by one or more objects in the path of the system output signal. When a system output signal is reflected, at least a portion of the reflected light travels back toward the LIDAR system as a system return signal. Each of the system return signals includes or consists of light from one of the system output signals. A system return signal and a system output signal that include light from the same alternate waveguide are associated with the same alternate waveguide and accordingly with the same waveguide index.

The LIDAR system can be configured such that LIDAR input signals each includes or consists of light from one of the system return signals. A LIDAR input signal and the system return signal that includes light from the same alternate waveguide are associated with the same alternate waveguide and accordingly with the same waveguide index. For instance, FIG. 1A illustrates three different LIDAR input signals that are each associated with a different one of the alternate waveguides. The LIDAR input signals are labeled Cᵢ where i represents the waveguide index. As shown in FIG. 1A, the LIDAR input signals can approach the LIDAR chip and/or be incident on the LIDAR chip from different directions.

The portion of each LIDAR input signal that enters the LIDAR chip serves as an incoming LIDAR signal. The LIDAR chip includes an input component 18 that receives the incoming LIDAR signals or receives light from the incoming LIDAR signals. The input component 18 outputs sub-incoming signals that each includes light from one of the incoming LIDAR signals. Each of the sub-incoming signals travels from the input component 18 to a comparative waveguide 26. The LIDAR system can be constructed such that different alternate waveguides 26 receive different sub-incoming signals. For instance, each of the sub-incoming signals can travel along one of multiple different second pathways that each extends from the input component 18 to one of the comparative waveguides 26.

The second pathways and/or the input component 18 can be configured such that each of the incoming LIDAR signals separates into multiple sub-incoming signals that each carries light in a different polarization state. As a result, each of the different sub-incoming signals can carry a different combination of wavelength channel and polarization state. For instance, the sub-incoming signals in FIG. 1A are labeled C_{i,pi} where i represents the waveguide index carried by the LIDAR input signal labeled C_{i,pi} and pi is a polarization state index that represents the polarization state of the light carried by the LIDAR input signal. For instance, the sub-incoming signal labeled C_{2,p1} can include light that is from the alternate waveguide associated with waveguide index i=2 and that is in the polarization state associated with polarization state index pi=1. Examples of polarization states include, but are not limited to, linear polarization states such as transverse-magnetic (TM) and transverse-electric (TE). Different polarization state indices can be associated with different polarization states. For instance, the polarization state index pi=1 can be associated with the TM polarization state and the polarization state index pi=2 can be associated with the TE polarization state. Using this example of polarization state index associations, the sub-incoming signal labeled C_{3,p2} can carry light that is from the alternate waveguide associated with waveguide index i=3 and in the TE polarization state. All or a portion of the sub-incoming light signals with polarization state index pi can each exclude or substantially exclude light in polarization states other than pi. For instance, the sub-incoming signal labeled C_{1,p2} can include light that is from the alternate waveguide associated with waveguide index i=1 and that is in the polarization state associated with polarization state index pi=2 and can exclude, or substantially exclude, light that is in the polarization state associated with polarization state index pi=1.

The LIDAR chip includes multiple comparative waveguides 26. Each of the sub-incoming signals is received at a different one of the comparative waveguides 26. The portion of a sub-incoming signal that enters a comparative waveguide 26 can serve as a comparative signal. Each of the comparative signals includes or consists of light from one of the sub-incoming signals. As a result, each of the comparative signals have a different combination of waveguide index and polarization state (C_{m,pi}). Each of the comparative waveguides 26 carries one of comparative signals to a signal processor 28 for further processing.

The LIDAR chip includes multiple splitters 24 and multiple reference waveguides 32. Each of the splitters 24 is positioned along a different one of the alternate waveguides 16. Each of the splitters is configured to move a portion of the outgoing LIDAR signal traveling along one of the alternate waveguides onto one of the reference waveguides 32. The portion of an outgoing LIDAR signal received on a reference waveguide 32 serves as a reference signal. Each of the reference signals is associated with the alternate waveguide 16 from which the reference signal originated. For instance, the reference waveguides 32 carrying the reference signals associated with the waveguide indices i=1 through i=3 are labeled C₁ through C₃ in FIG. 1A. Suitable splitters 42 include, but are not limited to, evanescent optical couplers, Y-junctions, and MMIs.

Each of the reference waveguides 32 carries a reference signal to one of the signal processors 28. The reference waveguides 32 are configured such that each of the signal processors 28 receives the reference signal and the comparative signal associated with the same alternate waveguide. As a result, each of the signal processors 28 receives a reference signal associated with waveguide index i and the comparative signal that is associated with the same waveguide index and carrying light in polarization state pi as represented by C_{i,pi}.

As will be described in more detail below, each of the signal processors 28 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can optionally include a control branch for controlling the operation of the light source 10. For instance, the control branch can provide a feedback loop that the light source controller 63 uses in operating the light source such that the outgoing LIDAR signal has the desired frequency versus time pattern.

The example control branch illustrated in FIG. 1A includes a directional coupler 66 that moves a portion of the outbound LIDAR signal from the utility waveguide 12 onto a control waveguide 68. The coupled portion of the outbound LIDAR signal serves as a tapped signal. Although FIG. 1A illustrates a directional coupler 66 moving the portion of the outbound LIDAR signal onto the control waveguide 68, other signal-taps can be used to move a portion of the outbound LIDAR signal from the utility waveguide 12 onto the control waveguide 68. Examples of suitable signal taps include, but are not limited to, Y-junctions, and MMIs.

The control waveguide 68 carries the tapped signal to a feedback system 70. The feedback system 70 can include one or more light sensors (not shown) that convert light signals carried by the feedback system 70 to electrical signals that are output from the feedback system 70. The light source controller 63 can receive the electrical signals output from the feedback system 70. During operation, the light source controller 63 can adjust the frequency of the outbound LIDAR signal in response to output from the electrical signals output from the feedback system 70. An example of a suitable construction and operation of feedback system 70 and light source controller 63 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1A illustrates the electronics 62 as a component that is separate from the signal processor(s) 28, a portion of the electronics 62 can be included in each of the signal processor(s) 28.

The electronics 62 can include a light source controller 63. The light source controller 63 can operate the light source 10 so as to control the wavelength channel carried in the outbound LIDAR signal and accordingly in the resulting outgoing LIDAR signal. Additionally, the light source controller 63 can operate the light source 10 such that the outbound LIDAR signal and the resulting outgoing LIDAR signals, LIDAR output signals and system output signals have a particular frequency versus time pattern. For instance, the light source controller 63 can operate the light source such that the outbound LIDAR signal, and accordingly the resulting outgoing LIDAR signals, LIDAR output signals and system output signals have different chirps during different data periods. Additionally, or alternately, the light source controller 63 can operate the light source such that the outbound LIDAR signal, outgoing LIDAR signals, LIDAR output signals and system output signals carry the wavelength channel that is currently desired for operation of the LIDAR system.

The LIDAR output signals can serve as the system output signals that are transmitted by the LIDAR system. Since the LIDAR output signals can travel away from the LIDAR chip in different directions, the light source controller 63 can scan the system output signals to different sample regions of the field of view by operating the light source 10 so as to change the channel wavelength carried by the outbound LIDAR signal. The change to the wavelength channel carried by the outbound LIDAR signal changes the wavelength channel carried by the outgoing LIDAR signals, LIDAR output signals and system output signals and accordingly changes the direction of the system output signals travel away from the LIDAR system.

The second pathways and/or the input component 18 need not separate each of the incoming LIDAR signals separates into multiple sub-incoming signals. For instance, FIG. 1B illustrates the LIDAR chip of FIG. 1A modified such that the input component 18 receives the incoming LIDAR signals and outputs the incoming LIDAR signals such that each of the comparative waveguides 26 receives the incoming LIDAR signals associated with a different one of the waveguide indices. The portion of an incoming LIDAR signal that enters a comparative waveguide 26 can serve as a comparative signal. Each of the comparative signals includes or consists of light from one of the incoming LIDAR signals. As a result, each of the comparative signals is associated with a different waveguide index (i). Each of the comparative waveguides 26 carries one of comparative signals to a signal processor 28 for further processing. As noted in the context of FIG. 1A, each of the reference waveguides 32 carries a reference signal to one of the signal processors 28. The reference waveguides 32 are configured such that each of the signal processors 28 receives the reference signal and the comparative signal associated with the same waveguide index.

The LIDAR system can include an optical component assembly 75 that receives the LIDAR output signals and outputs system output signals that each includes, consists of, or consists essentially of light from a different one of the LIDAR output signals. When the optical assembly 75 includes one or more active components such as movable mirrors, all or a portion of the one or more active components, the electronics 62 can operate the one or more active components so as to steer the system output signals to different sample regions in the LIDAR system's field of view.

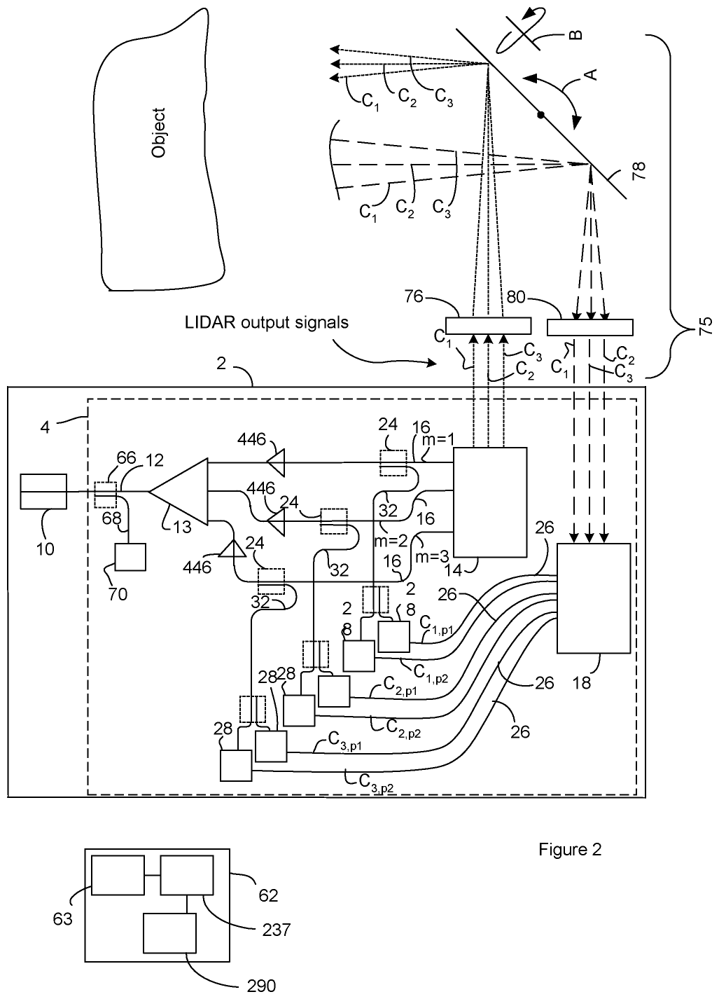

FIG. 2 illustrates an optical component assembly 75 that includes one or more optical components and receives the LIDAR output signals from the LIDAR chip. The LIDAR system optionally includes a beam shaper 76 that receives the LIDAR output signals from a LIDAR chip. The beam shaper 76 can change the of the LIDAR output signals. For instance, in some instances, the beam shaper 76 is configured to operate on the LIDAR output signals such that the LIDAR output signals output from the beam shaper 76 are collimated and/or the system output signals are collimated or substantially collimated as they travel away from the LIDAR system. Suitable beam shapers 76 include, but are not limited to, lenses such as convex lenses and cylindrical lenses, mirrors such as concave mirrors and combinations of these elements. A cylindrical lens can provide collimation of the LIDAR output signals in a direction that is orthogonal to the direction of collimation provided by the return surface 104.

The optical component assembly 75 can include one or more beam steerers configured to steer the system output signals. For instance, the optical component assembly 75 shown in FIG. 2 includes a beam steerer 78 that can receive the LIDAR output signals from optical component assembly 75. The portion of the LIDAR output signals output from the one or more beam steerers 78 can serve as the system output signals for the LIDAR system as shown in FIG. 2. The electronics 62 can operate the one or more beam steerers so as to steer each of the system output signal to different sample regions in the field of view. The beam steerer 78 shown in FIG. 2 can be a movable mirror. As is evident from the arrows labeled A and B in FIG. 2, the beam steerer 78 can be configured such that the electronics can steer the system output signals in one dimension or in two dimensions. As a result, the one or more beam steerers 78 can function as a beam-steering mechanism that is operated by the electronics so as to steer the system output signals within the field of view of the LIDAR system. Accordingly, the one or more system output signals output by the LIDAR system can be steered within the LIDAR system's field of view by operating the one or more beam steerers 78. In some instances, the light source controller 63 can scan the system output signals to different sample regions of the field of view by operating the light source 10 so as to change the channel wavelength carried by the system output signals. Accordingly, the electronics can steer the system output signals within the field of view of the LIDAR system by operating the one or more beam steerers 78 and/or by operating the light source 10 so as to change the channel wavelength carried by the system output signals.

Each of the system output signals can be reflected by one or more objects located outside of the LIDAR system. All or a portion of the reflected light from a system output signal can return to the LIDAR system as a system return signal. When the LIDAR system includes one or more beam steerers 78, each of the system return signals is received at the one or more beam steerers 78. The one or more beam steerers 78 output at least a portion of each of the system return signals as a returned signal.

The optical component assembly 75 illustrated in FIG. 2 includes a second beam shaper 80 that receives the returned signals from one or more beam steerers 78. The second beam shaper 80 changes the shape of the returned signals. When the LIDAR chip receives the returned signals from the second beam shaper 80 as shown in FIG. 2, the returned signals output from the second beam shaper 80 can each serve as one of the LIDAR input signals. In some instances, the second beam shaper 80 focusses at least a portion of the LIDAR input signals at a location on or within the LIDAR chip. For instance, the second beam shaper 80 can focus all or a portion of the LIDAR input signals on the facet 77 or within the free space region. Although the beam shaper 76 and the second beam shaper 80 are illustrated as separate components, the beam shaper 76 and the second beam shaper 80 can be a single component. For instance, the beam shaper 76 and the second beam shaper 80 can be a single lens such as a single cylindrical lens.

Suitable beam steerers 78 include, but are not limited to, movable mirrors, polygon mirrors, MEMS mirrors, optical phased arrays (OPAs), optical gratings, and actuated optical gratings. Suitable beam shapers 76 and/or second beam shapers 80 include, but are not limited to, lenses such as convex lenses and cylindrical lenses, mirrors such as concave mirrors and combinations of these elements. The optical components shown in the optical component assembly 75 of FIG. 2 are optional and other arrangements of the illustrated optical components are possible. A suitable optical component assembly 75 can include or consist of as few as one optical component. A suitable optical component assembly 75 can include or consist of optical components in addition to the illustrated optical components. For instance, a suitable optical component assembly 75 can include or consist of one or more collimating optical components (not illustrated) that operate on the LIDAR output signals such that the resulting system output signals are collimated or substantially collimated as they travel away from the LIDAR system. In some instances, the beam shaper 76 provides collimating functionality. For instance, the beam shaper 76 can be configured to collimate the LIDAR output signals.

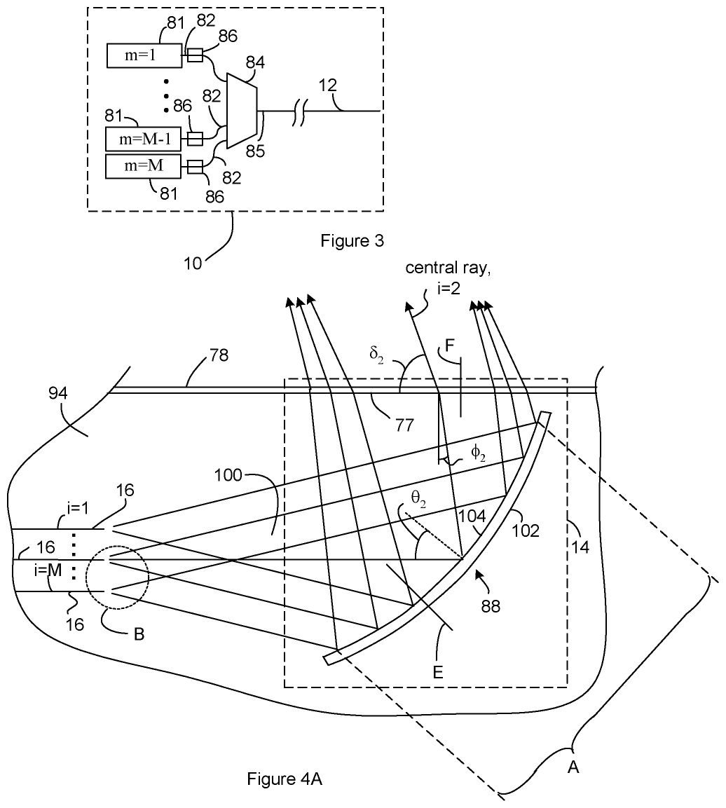

Although FIG. 1A through FIG. 2 illustrate the light source 10 as being positioned on the LIDAR chip, all or a portion of the light source 10 can be located off the LIDAR chip. FIG. 3 illustrates an example of a light source 10 suitable for use with the LIDAR system of FIG. 1A through FIG. 2. The light source 10 includes multiple laser sources 81. Suitable laser sources 81 include, but are not limited to, External Cavity Lasers (ECLs), Distributed Bragg Reflector laser (DBR), and Distributed Feedback lasers (DFB). When a laser source 81 includes one or more optical gratings, the one or more optical gratings can be integrated with the LIDAR chip or can be off the LIDAR chip.

Each of the laser sources 81 is configured to output a wavelength channel signal on a source waveguide 82. Each wavelength channel signal can carry one of the m=1 through M wavelength channels. For instance, FIG. 3 illustrates one possible arrangement where the source waveguide 82 the wavelength channel carried by each of the source waveguide 82 is labeled m=1 through m=M.

Each of the source waveguides 82 carries a wavelength channel signal to a signal mixer 84 that outputs the one or more wavelength channel signal(s) received by the signal mixer 84 on a channel waveguide 85. When the channel waveguide 85 is located on the LIDAR chip, the channel waveguide 85 can serve as the utility waveguide 12 and the wavelength channel signal output by the signal mixer 84 can serve as the outgoing LIDAR signal. The channel waveguide 85 can be located off the LIDAR chip and the utility waveguide 12 on the LIDAR chip can be configured to receive light signals that include or consist of light from the wavelength channel signal output by the signal mixer 84. For instance, the channel waveguide 85 can be an optical fiber configured to exchange the wavelength channel signal with a utility waveguide 12 on LIDAR chip. The portion of each wavelength channel signal received by the utility waveguide 12 can serve as the outbound LIDAR signal guided by the utility waveguide 12. A light signal mixer 84 can be a wavelength dependent multiplexer including, but not limited to, an Arrayed Waveguide Grating (AWG) multiplexer, and an echelle grating multiplexer. The light signal mixer 84 can also be a wavelength independent mixer including, but not limited to, cascaded Y-junctions, cascaded MMI splitters, and a star coupler.

The outbound LIDAR signal and the resulting outgoing LIDAR signals, LIDAR output signals, and system output signals each carries light from one of the wavelength channel signals. Since each of the wavelength channel signals carries one of the wavelength channels, the electronics can operate the light source 10 such that the outbound LIDAR signal received by the utility waveguides 12 carries one of the wavelength channels. For instance, the electronics can operate the laser sources 81 independently such that only one of the laser sources 81 outputs a wavelength channel signal while the other laser sources 81 do not output a wavelength channel signal or do not substantially output a wavelength channel signal. As an example, the light source controller 63 can turn on the laser sources 81 that outputs the desired wavelength channel signal and turn off the source(s) 81 that do not output the desired wavelength channel signal. When each of the laser sources 81 includes or consists of a gain element or laser chip, the light source controller 63 can apply an electrical current through the gain element or laser cavity in one of the laser sources 81 so as to cause that laser source to output a wavelength channel signal while refraining from applying an electrical current through the gain element or laser cavity in the one or more remaining laser source(s) 81 so they do not output a wavelength channel signal. As a result, the outbound LIDAR signal received by the utility waveguides 12 carries one of the wavelength channels. The electronics can also operate the laser source(s) 81 so as to change the wavelength channel carried by the outbound LIDAR signal. For instance, the light source controller 63 can change the laser source to which the electrical current is applied. The light source to which the electrical current is applied can be the light source that outputs the wavelength channel signal that carries the wavelength channel that is currently desired for the outbound LIDAR signal and the resulting outgoing LIDAR signals, LIDAR output signals, and system output signals.

The light source 10 can optionally include one or more modulators 86 that are each positioned so as to modulate one of the wavelength channel signals. For instance, the light source 10 can optionally include one or more modulators 86 positioned along each of the source waveguides 82. The light source controller 63 can operate each of the modulators 86 so as to allow a wavelength channel signal carried in a source waveguide 82 to pass the modulator 86 without attenuation from the modulator or such that the wavelength channel signal carried in a source waveguide 82 is attenuated by the modulator. The attenuation can be sufficient that the attenuated wavelength channel is not substantially present in the channel waveguide 85. As a result, the attenuation can be sufficient that the attenuated wavelength channel is not substantially present in the outbound LIDAR signals output from the light source and is accordingly not substantially present in the system output signals output from the LIDAR system. As a result, an alternative to the light source controller 63 turning laser sources 81 on and off so as to select the wavelength channel carried in the system output signals, the light source controller 63 can keep the laser sources that generate the needed channel wavelengths “on” and also operate the one or more modulators 86 so the outbound LIDAR signal carries the currently desired wavelength channel. Accordingly, the light source controller 63 can keep the laser sources that generate the channel wavelengths that will be needed “on” while operating the one or more modulators 86 so the system output signal(s) carry the currently desired wavelength channel. As an example, when it is desired for an outbound LIDAR signals and the resulting system output signals to carry wavelength channel m=2, the source controller 63 can operate laser sources 81 that generate channel wavelengths m=1 through m=M such that each of these laser sources 81 concurrently outputs a wavelength channel signal and can operate the modulators 86 such that the wavelength channel signal that carries wavelength channel m=2 passes the associate modulator 86 but the wavelength channel signals carrying wavelength channels m=2 and m=3 through Mare attenuated such that wavelength channels m=2 and m=3 through M are not substantially present in the resulting outgoing LIDAR signals and are accordingly not substantially present in the resulting system output signals. Suitable modulators 86 include, but are not limited to, Variable Optical Attenuators (VOAs), Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

Suitable waveguides for use as the source waveguide 82 and/or the channel waveguide 85 include, but are not limited to optical fibers and planar optical waveguides. Although FIG. 3 illustrates the light source 10 as separate from the LIDAR chip, all or a portion of the light source 10 can be positioned on the LIDAR chip and/or integrated into the LIDAR chip. As a result, suitable waveguides for use as the source waveguide 82 and/or the channel waveguide 85 also include, but are not limited to rib waveguides, ridge waveguides, buried waveguides.

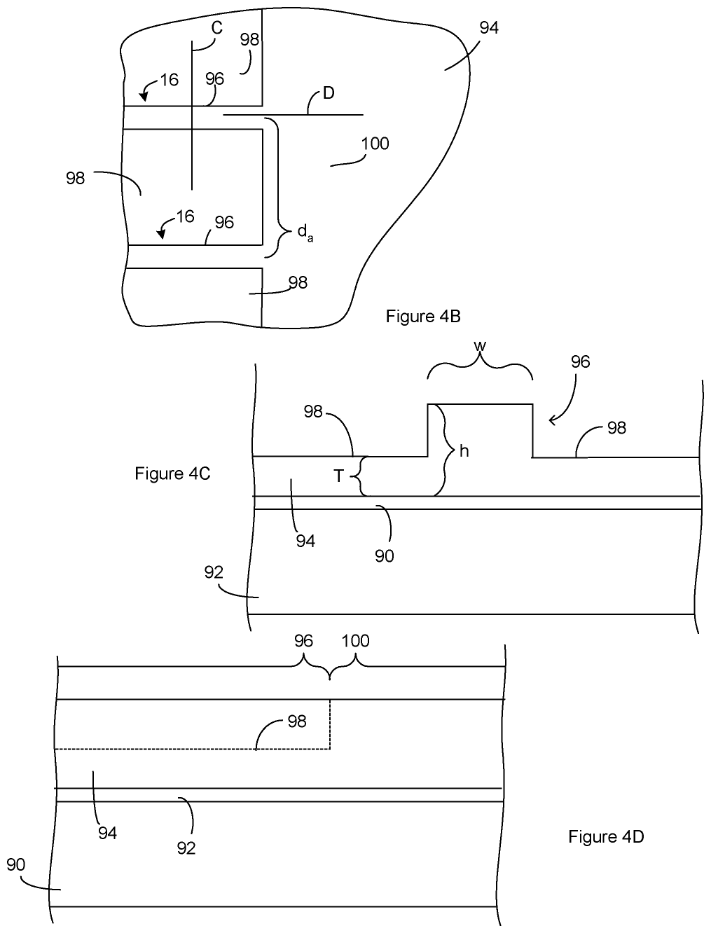

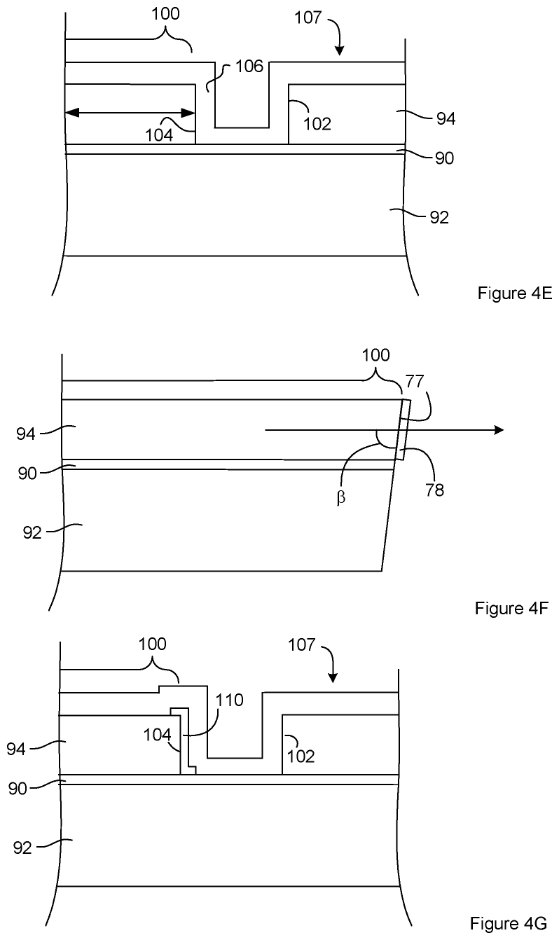

FIG. 4A through FIG. 4F illustrate an example of a suitable output component 14. FIG. 4A is schematic of a topview of the output component. FIG. 4B is a close-up of the portion of the output component encircled by the dashed line labeled B in FIG. 4A. FIG. 4C is a cross section of the output component taken along the line labeled C in FIG. 4B. FIG. 4D is a cross section of the output component taken along the line labeled D in FIG. 4B. FIG. 4E is a cross section of the output component taken along the line labeled E in FIG. 4A. FIG. 4F is a cross section of the output component taken along the line labeled F in FIG. 4A.

The output component includes a signal director 88 that receives the outgoing LIDAR signals from the alternate waveguides 16. The signal director 88 also redirects the received outgoing LIDAR signal such that the direction that each of the outgoing LIDAR signals travels away from the signal director 88 changes in response to changes in the alternate waveguide 16 from which the signal director 88 receives the outgoing LIDAR signal.

A lateral side of the LIDAR chip includes a facet 77 that receives the outgoing LIDAR signals from the signal director 88. The outgoing LIDAR signals can exit the LIDAR chip through the facet. The portion of an outgoing LIDAR signal that exits the LIDAR chip through the facet 77 can serve as a LIDAR output signal. The facet can optionally include an anti-reflective coating 78. Suitable anti-reflective coatings 78 include, but are not limited to, single layer dielectric coatings such as silicon nitride, multi-layer dielectric coatings including silica, hafnium oxide, and aluminum oxide.

Suitable platforms for the output component 14 include, but are not limited to, silica, indium phosphide, silicon nitride, and silicon-on-insulator wafers. FIG. 4B through FIG. 4F illustrate different portions of the output component 14 integrated into a silicon-on-insulator wafer. A silicon-on-insulator (SOI) wafer includes a buried layer 90 between a substrate 92 and a light-transmitting medium 94. In a silicon-on-insulator wafer, the buried layer 90 is silica while the substrate and the light-transmitting medium 94 are silicon. The substrate of an optical platform such as an SOI wafer can serve as the base for the output component. For instance, the optical components shown in FIG. 1A can be positioned on or over the top and/or lateral sides of the same substrate.

The portion of the chip illustrated in FIG. 4B through FIG. 4F includes a waveguide construction that is suitable for use with chips constructed from silicon-on-insulator wafers. A ridge 96 of the light-transmitting medium 94 extends away from slab regions 98 of the light-transmitting medium 94. The light signals are constrained between the top of the ridge and the buried layer 90. As a result, the ridge 96 at least partially defines the waveguide.

The dimensions of the ridge waveguide are labeled in FIG. 4C. For instance, the ridge has a width labeled w and a height labeled h. A thickness of the slab regions is labeled T. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 4C is suitable for all or a portion of the waveguides on a LIDAR chip.

The LIDAR chip includes a free space region 100 that extends from the signal director 88 to the lateral side of the LIDAR chip and from the signal director 88 to the alternate waveguides. The outgoing LIDAR signals travel through the free space region 100 between the alternate waveguides 16 and the signal director 88 and/or between the signal director 88 and the facet 77 at the later side of the LIDAR chip. The free space region 100 is free space in the horizontal direction but guided in the vertical direction and can accordingly be considered a partially free space region 100. As a result, the outgoing LIDAR signals and/or the incoming LIDAR signals can contract or expand horizontally when traveling through the partial free space region 100.

A portion of the free space region 100 can terminate at the facet 77 as is evident from FIG. 4F. The facet 77 can be at an angle β measured in a direction that is perpendicular to a plane of the LIDAR chip and relative to a direction of propagation of the LIDAR output signals in the free space region at the facet 77. The plane of the LIDAR chip can be an upper surface of a substrate such as the substrate 92 of FIG. 4A through FIG. 4C. The angle β can be less than 90° in order to reduce the effects of back reflection on the LIDAR output signal(s). Suitable values for the angle β include angles less than or equal to 12°, 10°, or 8° and/or greater than or equal to 7°, 6°, or 5°.

The illustrated signal director 88 includes a recess 102 that extends partially or fully through the light-transmitting medium 94. Although the illustrated recess 102 does not extend into the buried layer 90, the illustrated recess 102 can extend into or through buried layer 90. A surface of the recess 102 serves as a return surface 104. The return surface 104 is configured such that at least a portion of an outgoing LIDAR signal that is incident on the return surface 104 from the light-transmitting medium 94 returns to the light-transmitting medium 94. The mechanism by which the return occurs can be reflected at or by the return surface 104. For instance, a recess medium 106 can be positioned in the recess 102 and in contact with the return surface 104. The recess medium 106 can fill the recess 102 or be a layer of material that contacts the return surface 104. The recess medium 106 can be a fluid or a solid. As shown in FIG. 4E, the recess medium 106 can be a solid that also serves as a cladding 107 for the output component. In some instances, the recess medium 106 has a lower index of refraction than the light-transmitting medium 94 to cause reflection at the return surface 104. Suitable recess media with an index of refraction lower than the light-transmitting medium 94 include, but are not limited to, air, epoxies, silicon dioxide, and silicon nitride. Suitable recess media with an index of refraction lower than the light-transmitting medium 94 that can also serve as cladding include, but are not limited to, silicon dioxide, and silicon nitride.

In some instances, the recess medium 106 is a medium that causes reflection of the outgoing LIDAR signals at the return surface 104. For instance, the recess medium 106 can be a reflective material 110 that contacts the return surface 104. FIG. 4G illustrates a layer of reflective material 110 in contact with the return surface 104. Although FIG. 4G illustrates a cladding positioned on the output component such that the cladding is located over the recess medium 106 and extends into the recess 102, the cladding is optional. Suitable reflective materials 110 include, but are not limited to, multi-layer dielectric films including silicon dioxide, hafnium oxide and aluminum oxide, and metals such as aluminum, nickel, and gold. Suitable claddings include, but are not limited to, silicon dioxide, silicon nitride, and aluminum oxide.

The signal director 88 and the return surface 104 are arranged such that an incident angle of an outgoing LIDAR signal on the return surface 104 is a function of the alternate waveguide from which the signal director 88 receives the outgoing LIDAR signal. As a result, the angle of incidence of the outgoing LIDAR signals on the return surface 104 changes in response to changes in the alternate waveguide 16 from which the outgoing LIDAR signal exits. For instance, in one example, the alternate waveguides 16 can be parallel and the return surface 104 can be curved. In some instances, the return surface 104 is a smooth and curved surface that acts as a mirror. In one example, the return surface 104 is parabolic, spherical, or aspherical and can be optimized to achieve the desired light throughput. In one example, the return surface 104 is substantially parabolic or approximately parabolic. The shape of the return surface can be selected to provide collimation or focusing of the outgoing LIDAR signal. A parabolic return surface may provide a tighter focus than a spherical return surface. Since the incident angle changes in response to changes in the alternate waveguide 16, changing the alternate waveguide 16 that outputs the outgoing LIDAR signal changes the direction that the outgoing LIDAR signal travels away from the signal director 88. As an example, θᵢ can represent the angle of incidence for the outgoing LIDAR signal from the alternate waveguide 16 associated with waveguide index i on the return surface 104. FIG. 4A labels the angle of incidence for the central ray of outgoing LIDAR signal that exits the alternate waveguide 16 associated with waveguide index i=2 as θ₂. The value of θᵢ changes as the waveguide index i changes from i=2 to another value.

The orientation of the signal director 88 relative to the facet 77 produces an angle of incidence for the outgoing LIDAR signal associated with waveguide index i on the facet that changes as the alternate waveguide 16 changes. For instance, FIG. 4A labels the angle of incidence for the central ray of the output LIDAR signal associated with waveguide index i=2 on the facet 77 as ϕ₂. The LIDAR output signal associated with waveguide index i travels away from the output component 14 in an angular direction (δᵢ) that changes as the alternate waveguide 16 changes. For instance, FIG. 4A labels the angular direction of the LIDAR output signal associated with waveguide index i=2 relative to the facet (δᵢ) as δ₂. The value of both δᵢ and ϕᵢ changes as the value of i changes. The refraction of the LIDAR output signal at the facet 77 can increase the size of the field of view for the LIDAR system.

In some instances, the LIDAR system is constructed to have one, two, or three conditions selected from the group consisting of: an angle of incidence (θₘ) for at least one, two, three, four, or all of the alternate waveguides 16 greater than 10°, 25°, or 30° and/or less than 40°, 50°, or 60°; an angle of incidence (ϕₘ) for at least one, two, three, four, or all of the alternate waveguides 16 greater than 0°, 2°, or 5° and/or less than 10°, 15°, or 30°; and an angular direction (δₘ) for at least one, two, three, four, or all of the alternate waveguides 16 greater than 10°, 25°, or 50° and/or less than 60°, 75°, or 90°.

The use of a reflective material 110 disclosed in the context of FIG. 4G can become more desirable as the number (M) of angles of incidences (ϕₘ) that fall below the critical angle for total internal reflection (ϕ_{c}) increases. In some instances, all or a portion of the M angles of incidence (ϕₘ) fall below the critical angle for total internal reflection (ϕ_{c}) and the recess medium 106 is a reflective material 110 such as a metal. In some instances, none of the M angles of incidence (ϕₘ) j falls below the critical angle for total internal reflection (ϕ_{c}) and the recess medium 106 is a light-transmitting material with an index of refraction below the light-transmitting medium.

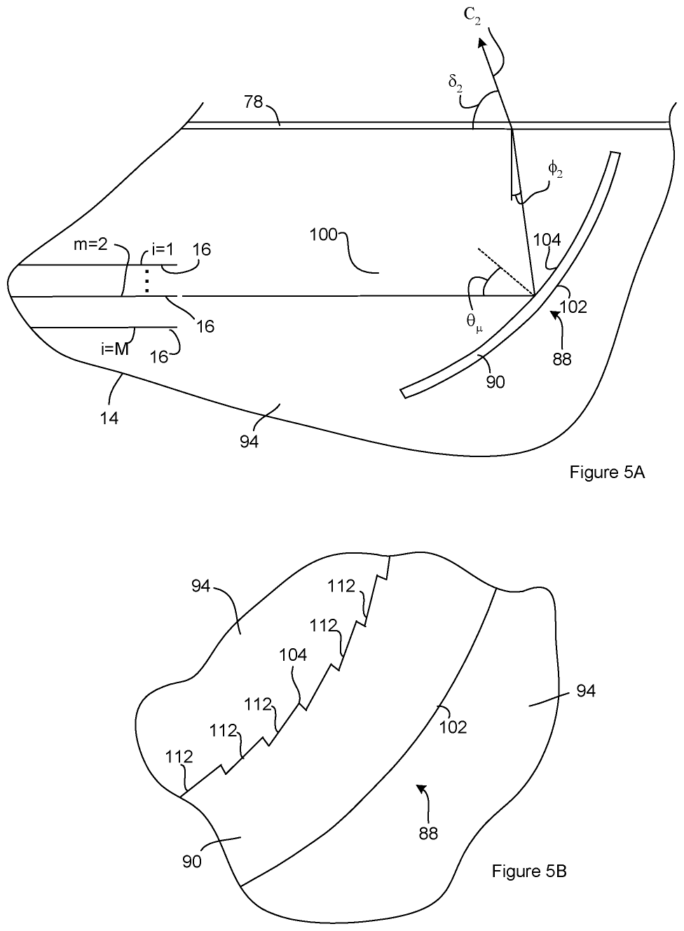

The output component 14 can be configured to provide demultiplexing functionality. For instance, the output component 14 can provide demultiplexing of the outgoing LIDAR signals. In one example, the demultiplexing functionality is achieved by modifying the return surface 104 to provide wavelength dispersion. For instance, the return surface 104 can be configured as an optical grating. FIG. 5A illustrates the return component 14 of FIG. 4A modified such that the return surface 104 acts an optical grating. An outgoing LIDAR signal is shown exiting from the alternate waveguide 16 associated with waveguide index i=2. The outgoing LIDAR signal is received by the signal director 88. Suitable optical gratings for the signal director 88 include, but are not limited to, an echelle grating. As an example, FIG. 5B is a topview of the return component of FIG. 4A modified such that the return surface 104 acts as an optical grating. Rather than being a smooth surface, the return surface 104 includes multiple grooves 112. The grooves 112 can be arranged as an optical grating such as an echelle grating. Suitable groove 112 structures include, but are not limited to, steps.

When the output component 14 has demultiplexing functionality, changes to the wavelength channel carried by the outgoing LIDAR signals leads to a change in the direction that the outgoing LIDAR signals travels away from the output component 14. For instance, when the return surface 104 can be configured as an optical grating such as an echelle grating, changing the wavelength channel carried by the outgoing LIDAR signals changes the direction that the outgoing LIDAR signals travel away from the return surface 104. The change in the direction that the outgoing LIDAR signals travels away from the output component leads to changes in the directions that the LIDAR output signals travel away from the LIDAR chip. The change in the direction that the LIDAR output signals travel away from the LIDAR chip changes the direction that the system output signals travel away from the LIDAR system. As a result, the light source controller 63 can steer system output signals within the field of view by changing the wavelength channel carried by the outgoing LIDAR signals.

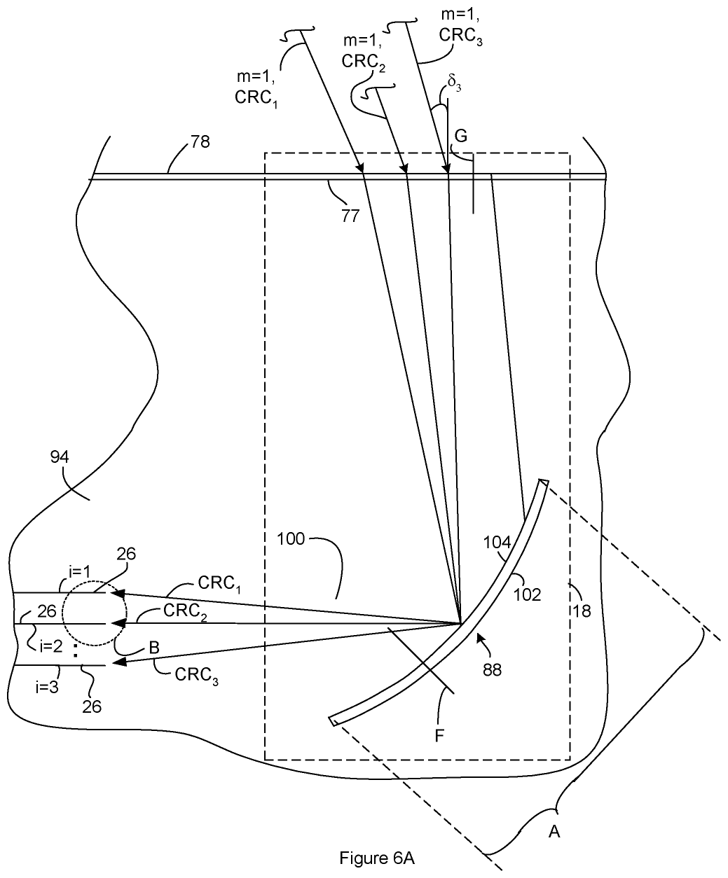

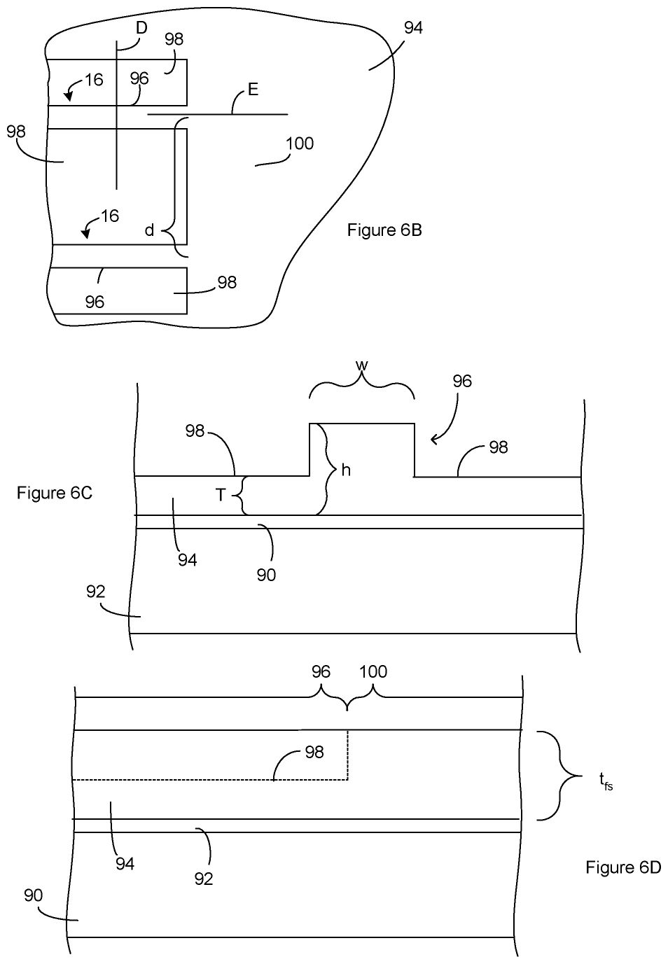

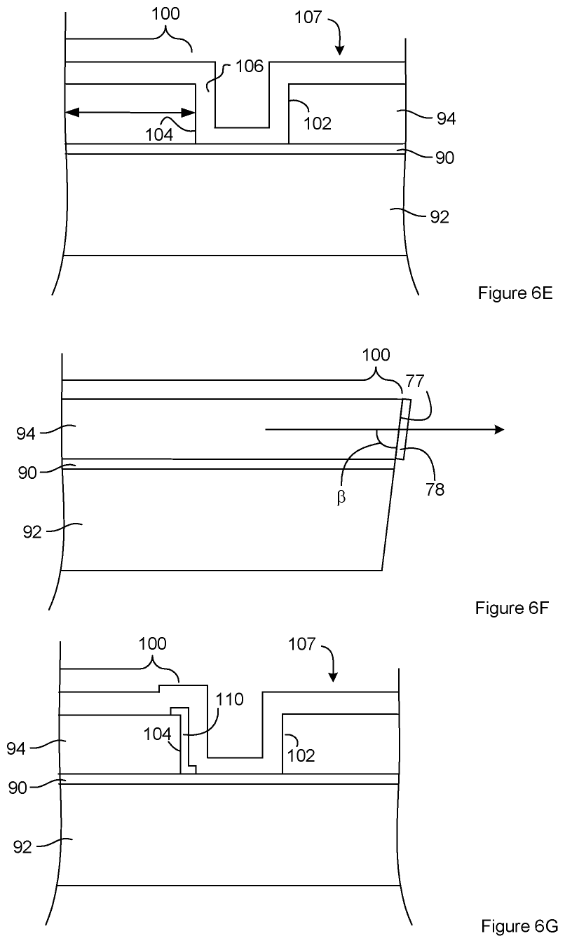

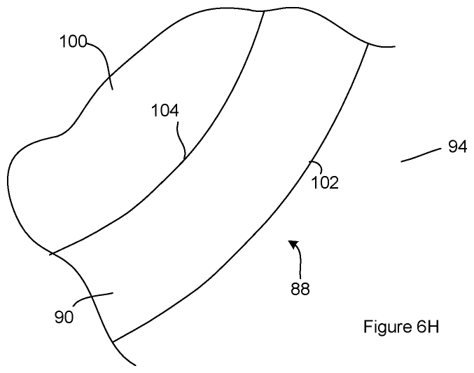

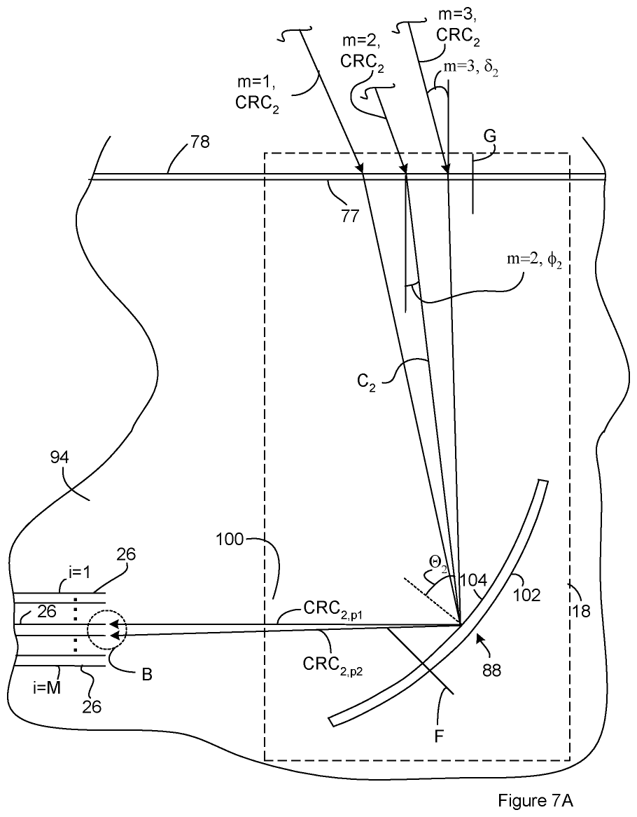

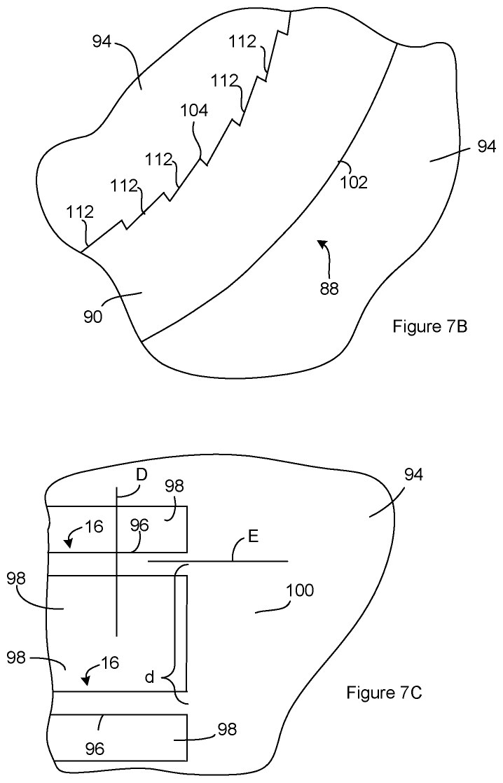

The input component 18 can be constructed according to the output component of FIG. 4A through FIG. 5B. For instance, FIG. 6A through G FIG. 6A through FIG. 6F illustrate an example of a suitable input component 18. FIG. 6A is schematic of a topview of an example of an input component. FIG. 7B is a close-up of a portion of a signal director 88 included in the input component of FIG. 6A. FIG. 6B is a close-up of the portion of the input component encircled by the dashed line labeled B in FIG. 6A. FIG. 6C is a cross section of the input component taken along the line labeled D in FIG. 6B. FIG. 6D is a cross section of the input component taken along the line labeled E in FIG. 6B. FIG. 6E is a cross section of the input component taken along the line labeled F in FIG. 6A. FIG. 6F is a cross section of the input component taken along the line labeled G in FIG. 6A.

The LIDAR chip includes a free space region 100 that extends from the signal director 88 to the lateral side of the LIDAR chip and from the signal director 88 to the alternate waveguides. In some instances, the free space region 100 extends from the return surface 104 to the facet at the lateral side of the LIDAR chip and/or from the return surface 104 to the entries of the comparative waveguides 26. The incoming LIDAR signals can enter the free space region 100 through the facet 77 at the lateral edge of the LIDAR chip. FIG. 6A labels the central rays for LIDAR input signals that are incident on the facet 77, that are each associated with channel wavelength index m=1, and are each associated with an alternate waveguide having waveguide index i=1 through 3 as CRC₁ through CRC₃. When the field of view of the LIDAR system includes one or more objects that reflect the system output signals concurrently transmitted from the LLIDAR system, the LIDAR chip can concurrently receive multiple different LIDAR input signals that are each associated with a different one of the reflected LIDAR signals in that the LIDAR input signals and the associated system output signal are each associated with the same waveguide channel. Since FIG. 6A illustrates the LIDAR chip concurrently receiving multiple different LIDAR input signals associated with the same channel wavelength index m=1 that originate from different alternate waveguides (i.e., associated with different waveguide indices), FIG. 6A can represent the state of the LIDAR chip at a moment in time.

The LIDAR input signals can enter the LIDAR chip through the facet 77. The facet 77 can optionally include an anti-reflective coating 78. Suitable anti-reflective coatings 78 include, but are not limited to, single layer dielectric coatings such as silicon nitride, multi-layer dielectric coatings including silica, hafnium oxide, and aluminum oxide. The portion of an LIDAR input signal that enters the LIDAR chip through the facet 77 can serve as one of the incoming LIDAR signals. The LIDAR input signals shown in FIG. 6A have different angles of incidence on the facet 77 and the resulting incoming LIDAR signals have different angles of refraction. As an example, the angle of incidence on the facet 77 for the LIDAR input signal associated with channel wavelength index m=1 and labeled CRC₃ in FIG. 6A is labeled δ₃. The difference between the angles of incidence for the different LIDAR input signals shown in FIG. 6A can be a result of the system output signals associated with different waveguide indices traveling away from the LIDAR system in different directions.

The incoming LIDAR signals travel from the facet 77 through the free space region 100. The input component includes a signal director 88 that receives the incoming LIDAR signals from the free space region 100. The signal director 88 redirects the received incoming LIDAR signals back through the partial free space region 100 such that the incoming LIDAR signals associated with different waveguide indices are each directed toward different comparative waveguides 26. Accordingly, different comparative waveguides 26 receive incoming LIDAR signals associated with different waveguide indices. As a result, the comparative waveguides 26 can each be associated with the waveguide index of the incoming LIDAR signals received by the comparative waveguide 26.

Suitable platforms for the input component 14 include, but are not limited to, silica, indium phosphide, and silicon-on-insulator wafers. FIG. 6B through FIG. 6F illustrate different portions of the input component 14 integrated into a silicon-on-insulator wafer. A silicon-on-insulator (SOI) wafer includes a buried layer 90 between a substrate 92 and a light-transmitting medium 94. In a silicon-on-insulator wafer, the buried layer 90 is silica while the substrate and the light-transmitting medium 94 are silicon. The substrate of an optical platform such as an SOI wafer can serve as the base for the input component. For instance, the optical components shown in FIG. 1A can be positioned on or over the top and/or lateral sides of the same substrate.

The portion of the chip illustrated in FIG. 6B through FIG. 6F includes a waveguide construction that is suitable for use with chips constructed from silicon-on-insulator wafers. A ridge 96 of the light-transmitting medium 94 extends away from slab regions 98 of the light-transmitting medium 94. The light signals are constrained between the top of the ridge and the buried layer 90. As a result, the ridge 96 at least partially defines the waveguide.

The dimensions of the ridge waveguide are labeled in FIG. 6C. For instance, the ridge has a width labeled w and a height labeled h. A thickness of the slab regions is labeled T. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 6C is suitable for all or a portion of the waveguides on a LIDAR chip.

The incoming LIDAR signals travel through a partial free space region 100 between the comparative waveguide 26 and the signal director 88 and/or between the signal director 88 and the facet 77. The partial free space region 100 is free space in the horizontal direction but guided in the vertical direction. As a result, the incoming LIDAR signals can contract or expand horizontally when traveling through the partial free space region 100.

A portion of the free space region 100 can terminate at the facet 77 as is most evident from FIG. 6F. The facet 77 can be at an angle β measured in a direction that is perpendicular to a plane of the LIDAR chip and relative to a direction of propagation of the LIDAR output signal(s) in the free space region at the facet 77. The plane of the LIDAR chip can be an upper surface of a substrate such as the substrate 92 of FIG. 6A through FIG. 6C. The angle β can be less than 90° in order to reduce the effects of back reflection on the LIDAR output signal(s). Suitable values for the angle β include angles less than or equal to 12°, 10°, or 8° and/or greater than or equal to 7°, 6°, or 5°.

The illustrated signal director 88 includes a recess 102 that extends partially or fully through the light-transmitting medium 94. Although the illustrated recess 102 does not extend into the buried layer 90, the illustrated recess 102 can extend into or through buried layer 90. A surface of the recess 102 serves as the return surface 104. The return surface 104 is configured such that at least a portion of the incoming LIDAR signal that is incident on the return surface 104 from the light-transmitting medium 94 returns to the light-transmitting medium 94. The mechanism by which the return occurs can be reflection at or by the return surface 104. For instance, a recess medium 106 can be positioned in the recess 102 and in contact with the return surface 104. The recess medium 106 can fill the recess 102 or be a layer of material that contacts the return surface 104. The recess medium 106 can be a fluid or a solid. As shown in FIG. 6E, the recess medium 106 can be a solid that also serves as a cladding 107 for the input component. In some instances, the recess medium 106 has a lower index of refraction than the light-transmitting medium 94 to cause reflection at the return surface 104. Suitable recess media with an index of refraction lower than the light-transmitting medium 94 include, but are not limited to, air, epoxies, silicon dioxide, and silicon nitride. Suitable recess media with an index of refraction lower than the light-transmitting medium 94 that can also serve as cladding include, but are not limited to, silicon dioxide, and silicon nitride.

In some instances, the recess medium 106 is a medium that causes the incoming LIDAR signal to be reflected at the return surface 104. For instance, the recess medium 106 can be a reflective material 110 that contacts the return surface 104. FIG. 6G illustrates a layer of reflective material 110 in contact with the return surface 104. Although FIG. 6G illustrates a cladding positioned on the input component such that the cladding is located over the recess medium 106 and extends into the recess 102, the cladding is optional. Suitable reflective materials 110 include, but are not limited to, multi-layer dielectric films including silicon dioxide, hafnium oxide and aluminum oxide, and metals such as aluminum, nickel, and gold. Suitable claddings include, but are not limited to, silicon dioxide, silicon nitride, and aluminum oxide.

The signal director 88 and the return surface 104 are arranged such that incoming LIDAR signals that carry the same wavelength channel but are associated with different waveguide indices have different angles of incidence on the return surface of the signal director 88 (Θᵢ). As a result, the angle of incidence of the incoming LIDAR signal on the return surface 104 changes in response to changes in the alternate waveguide 16 from which light included in the incoming LIDAR signal exits.

In some instances, the return surface 104 is curved. For instance, the return surface 104 is a smooth and curved surface that acts as a mirror. The curve of the return surface 104 can focus each of the incoming LIDAR signals at an entry of one of the comparative waveguides 26. In one example, the return surface 104 is parabolic, spherical, or aspherical and can be optimized to achieve the desired light throughput. In another example, the return surface 104 is substantially parabolic. In some instances, the shape of the return surface can be selected to provide collimation or focusing of the outgoing LIDAR signal.

The center-to-center distance between the entries to adjacent comparative waveguides 26 are labeled d in FIG. 6B. In some instances, all or a portion of the adjacent comparative waveguides 26 have a center-to-center distance greater than 2, 10, or 50 μm and/or less than 100, 200, or 500. In some instances, the free space region is configured such that all or a portion of the incoming LIDAR signals each has a central ray that travels a distance from the return surface 104 to the entry of a comparative waveguides 26 that is greater than 2, 5, or 10 mm and less than 20, 30, or 40 mm.

When the LIDAR chip includes alternate waveguides and an output component 14, the center-to-center distance between the entries to adjacent comparative waveguides 26 (d) can increase as the center-to-center distance between the exits from adjacent alternate waveguides 16 (labeled dₐ in FIG. 4B) increases. In some instances, the center-to-center distance between the entries to adjacent comparative waveguides 26 can be the same or about the same as the center-to-center distance between the exits from adjacent alternate waveguides 16 (labeled dₐ in FIG. 4B). In some examples, all or a portion of the alternate waveguides 16 have a center-to-center distance (dₐ) greater than 2, 10, or 50 μm and/or less than 100, 200, or 500.

The return surface 104 can be a smooth and curved surface that acts as a mirror as is evident from FIG. 6H. However, the return surface 104 can include an optical grating that provides multiplexing functionality. As an example, FIG. 7A illustrates the input component of FIG. 6A adapted to have a return surface that includes an optical grating with multiplexing functionality. As a result, incoming LIDAR signals carrying different channel wavelengths but being associated with the same waveguide index are directed to the same comparative waveguide(s) while incoming LIDAR signals associated with different waveguide indices are directed to different comparative waveguide(s). As an example, the central rays for LIDAR input signals that are incident on the facet 77, that are each associated with a different channel wavelength index m=1 through m=3, and are each associated with waveguide index i=2 are labeled in FIG. 7A as CRC₂ in combination with m=1 through 3. Since each LIDAR input signal associated with a waveguide index can carry a series of different channel wavelengths, FIG. 6A can represent the state of the LIDAR chip over a period of time period during which the channel wavelength carried by the illustrated LIDAR input signal changed.

The LIDAR input signals can enter the LIDAR chip through the facet 77. The portion of a LIDAR input signal that enters the LIDAR chip through the facet 77 can serve as one of the incoming LIDAR signals. The LIDAR input signals shown in FIG. 7A have different angles of incidence on the facet 77 and the resulting incoming LIDAR signals have different angles of refraction. As an example, the angle of incidence on the facet 77 for the LIDAR input signal associated with channel wavelength index m=3 and labeled CRC₂ in FIG. 7A is labeled 62. The difference between the angles of incidence for the different LIDAR input signals shown in FIG. 7A can be a result of the system output signals carrying different channel wavelengths while being associated with the same waveguide index traveling away from the LIDAR system in different directions.

The incoming LIDAR signals travel from the facet 77 through the free space region 100. The signal director 88 receives the incoming LIDAR signals from the free space region 100. The signal director 88 redirects the received incoming LIDAR signals back through the partial free space region 100. The multiplexing functionality of the return surface 104 combined with the configuration of the free space region can cause the incoming LIDAR signals to separate into multiple sub-incoming signals that each carries light in a different polarization state. As a result, each of the different sub-incoming signals can carry light with a different combination of waveguide index and polarization state. For instance, the central ray for the incoming LIDAR signal carrying channel wavelength m=2 and associated with alternate waveguide i=2 is labeled C₂ FIG. 7A. The sub-incoming signals that result from the incoming LIDAR signal labeled C₂ are labeled CRC_{2,pi} and CRC_{2,p2}. The comparative waveguides 26 are positioned such that different sub-incoming signals are received at different comparative waveguides 26. Accordingly, FIG. 6A illustrates a first one of the comparative waveguides 26 receiving the sub-incoming signal labeled C_{2,pi} and a second one of the comparative waveguides 26 receiving the sub-incoming signal labeled C_{2,p2}. The portion of a sub-incoming signal that enters a comparative waveguide 26 serves as a comparative signal guided by the comparative waveguide 26.

The signal director 88 and the free space region 100 can be configured to provide the separation of the sub-incoming signals. For instance, the return surface 104 can be configured as an optical grating that provides multiplexing functionality such as a diffraction grating. Additionally, the light-transmitting medium 94 that receives the incoming LIDAR signals from the optical grating can be a birefringent structure. A birefringent structure has different effective indices of refraction for different polarization states traveling through the birefringent structure. For instance, the free space region 100 that receive incoming LIDAR signals from the optical grating can have different effective indices of refraction for incoming LIDAR signals that have the same wavelength but different polarization states, such as TE and TM. As a result, an incoming LIDAR signal output from the optical grating with multiple different polarization states separate into the sub-incoming signals as they travel through the free space region 100 because the different polarization states have a different effective index of refraction in the light-transmitting medium 94.

FIG. 7B is a closeup of a portion of the return component 14 of FIG. 7A and provides an example of a return surface 104 that includes an optical grating. The return surface 104 includes multiple grooves 112 that define reflective elements. Suitable groove 112 structures include, but are not limited to, steps. The grooves 112 can be arranged so as to provide a diffraction grating such as an echelle grating. Suitable optical gratings for the signal director 88 include, but are not limited to, diffraction gratings. Suitable diffraction gratings include, but are not limited to, reflective diffraction gratings and transmission diffraction gratings. Suitable reflective diffraction gratings include, but are not limited to, echelle gratings.

Steering of the system output signals can change the angles of incidence of the incoming LIDAR signals on the signal director 88 (Θᵢ). For instance, the direction that the system output signals travel away from the LIDAR system changes when the electronics operate the light source so as to change the wavelength channel carried by the outgoing LIDAR signals, the LIDAR output signals, and the system output signals. The change in the direction of the system output signals changes the angles of incidence of the incoming LIDAR signals on the return surface of the signal director 88 (Θᵢ).

FIG. 7C is a close-up of the portion of the input component encircled by the dashed line labeled B in FIG. 7A. The center-to-center distance between the entries to adjacent comparative waveguides 26 that receive incoming LIDAR signals that are associated with the same waveguide index but different polarization states is labeled d in FIG. 7C. In some instances, all or a portion of the adjacent comparative waveguides 26 that receive incoming LIDAR signals that are associated with the same waveguide index but different polarization states have a center-to-center distances greater than 1, 1.5, or 2 μm and/or less than 3, 4, or 5 μm.

The distance d can increase as the degree of separation between sub-incoming signals that are associated with the same waveguide index but carry light in different polarization states increases. This degree of separation is a function of the thickness of the free space region 100 labeled t_{fs} in FIG. 6D. For instance, the separation between sub-incoming signals that are associated with the same waveguide index but have different polarization states can increase as the thickness of the free space region (t_{fs}) decreases. In some instances, the thickness of the free space region (t_{fs}) is constant. In some instances, thickness of the free space region (t_{fs}) decreases as the free space region 100 approaches the entry of all of a portion of the comparative waveguides 26. For instance, the thickness of the path that one or more of the sub-incoming signals travels through the free space region (t_{fs}) can decrease between the return surface 104 and the entry of the comparative waveguide 26 that receives the sub-incoming signal. In some instances, all or a portion of the thickness of the free space region (t_{fs}) is greater than 1, 2, or 3 μm and less than 4, 5, or 6 μm. The degree of separation is also a function of the distance that a central ray of the sub-incoming signals travels from the beam shaper 76 to the entry of a comparative waveguides 26. For instance, the separation between sub-incoming signals that are associated with the same waveguide index but different polarization states can increase as the distance that the central rays of the sub-incoming signals travel from the beam shaper 76 to the entry of a comparative waveguides 26 increases. In some instances, all or a portion of the sub-incoming signals have a central ray that travels a distance from the beam shaper 76 to the entry of a comparative waveguides 26 that is greater than 1, 2, or 4 mm and less than 6, 8, or 10 mm.

The center-to-center distance between the entries to adjacent comparative waveguides 26 that receive incoming LIDAR signals that are associated with different waveguide indices can be a function of grating angle of incidence, diffraction order and waveguide effective index. In some instances, all or a portion of the adjacent comparative waveguides 26 that receive incoming LIDAR signals that are associated with different waveguide indices have a center-to-center distances greater than 1, 1.5, or 2 μm and/or less than 4, 5, or 6 μm.

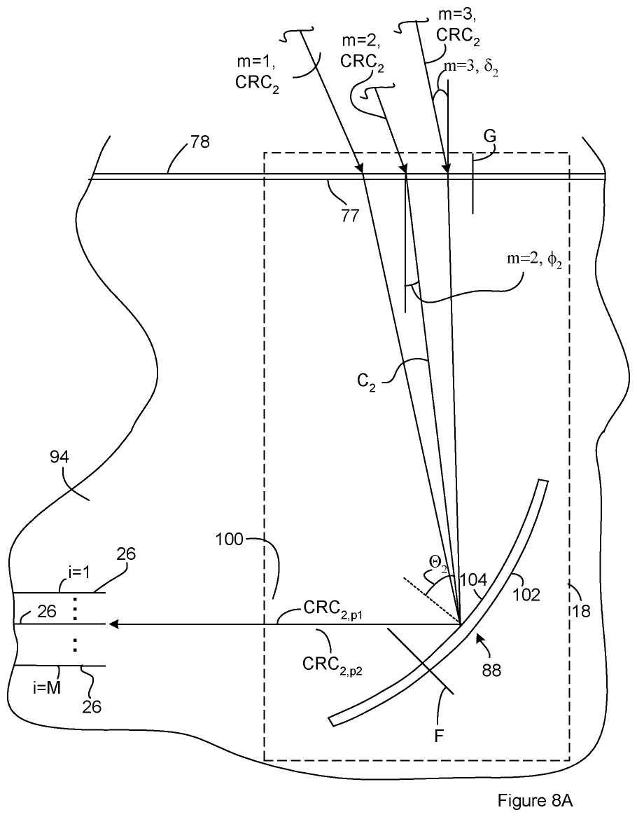

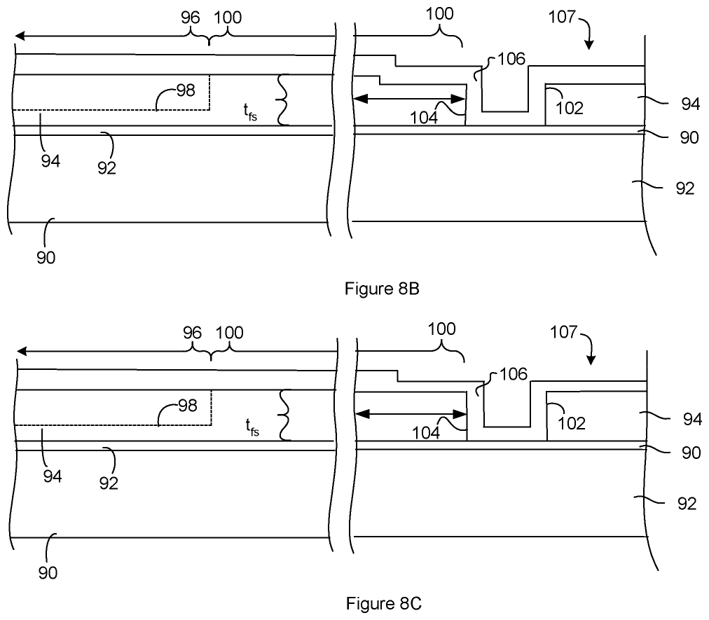

The input component can have multiplexing functionality without separating the incoming LIDAR signals into sub-incoming signals. As an example, FIG. 8A illustrates the input component of FIG. 6A adapted to have a return surface that includes an optical grating with multiplexing functionality. As a result, incoming LIDAR signals carrying different channel wavelengths but being associated with the same waveguide index are directed to the same comparative waveguide while incoming LIDAR signals associated with different waveguide indices are directed to different comparative waveguide. As an example, the central rays for LIDAR input signals that are incident on the facet 77, that are each associated with a different channel wavelength index m=1 through m=3, and are each associated with waveguide index i=2 are labeled in FIG. 7A as CRC₂ in combination with m=1 through 3.

The LIDAR input signals can enter the LIDAR chip through the facet 77. The portion of a LIDAR input signal that enters the LIDAR chip through the facet 77 can serve as one of the incoming LIDAR signals. The LIDAR input signals shown in FIG. 7A have different angles of incidence on the facet 77 and the resulting incoming LIDAR signals have different angles of refraction. As an example, the angle of incidence on the facet 77 for the LIDAR input signal associated with channel wavelength index m=3 and labeled CRC₂ in FIG. 7A is labeled 62. The difference between the angles of incidence for the different LIDAR input signals shown in FIG. 8A can be a result of the system output signals carrying different channel wavelengths while being associated with the same waveguide index traveling away from the LIDAR system in different directions. Accordingly, the difference between the angles of incidence for the different LIDAR input signals shown in FIG. 8A can result from demultiplexing functionality in the output component.

The incoming LIDAR signals travel from the facet 77 through the free space region 100. The beam shaper 88 receives the incoming LIDAR signals from the free space region 100. The beam shaper 88 redirects the received incoming LIDAR signals back through the partial free space region 100. The incoming LIDAR signals associated with the same waveguide index are received at the same comparative waveguide 26,

The free space region 100 can be constructed so as to prevent or reduce the separation of the incoming LIDAR signals into sub-incoming signals. For instance, the free space region can be constructed as shown in FIG. 6D. The thickness of the free space region 100 labeled t_{fs} in FIG. 6D. Separation between different polarization states can decrease as the thickness of the free space region (t_{fs}) increases moving from the return surface 104 to the entry of the comparative waveguide 26 that receives an incoming LIDAR signal. For instance, the thickness of the free space region (t_{fs}) can have one or more stepwise increases in the thickness between the return surface 104 to the entry of all or a portion of the comparative waveguides 26 as illustrated in FIG. 8B. Alternately or additionally, the thickness of the free space region (t_{fs}) can have one or more smooth increases in the thickness between the return surface 104 to the entry of all or a portion of the comparative waveguides 26. As an alternative to increasing the thickness of the free space region (t_{fs}), or in addition to increasing the thickness of the free space region (t_{fs}), the cladding 107 over the free space region 100 can increase one or more times moving from the return surface 104 toward the entry of all or a portion of the comparative waveguides 26 as illustrated in FIG. 8C. In some instances, all or a portion of the thickness of the free space region (t_{fs}) is greater than 1, 2, or 3 μm and less than 4, 5, or 6 μm. The degree of separation of polarization states is also a function of the distance that a central ray of an incoming LIDAR signals travels from the return surface 104 to the entry of a comparative waveguides 26. For instance, the separation between sub-incoming signals that are associated with the same waveguide index but different polarization states can decrease as the distance that the central rays of the sub-incoming signals travel from the return surface 104 to the entry of a comparative waveguides 26 decreases. In some instances, all or a portion of the sub-incoming signals have a central ray that travels a distance from the return surface 104 to the entry of a comparative waveguides 26 that is greater than 2, 5, or 10 mm and less than 20, 30, or 40 mm.

The return surfaces 104 of the input components and the return surfaces of the output components disclosed above have an aperture. As an example, the aperture of the return surface 104 of the input component shown in FIG. 6A is labeled A. The return surfaces 104 of the output components can have an effective aperture that is smaller than the actual aperture. The effective aperture can be the portion of the actual aperture through which the outgoing LIDAR signals pass during operation of the LIDAR system. As an example, the effective aperture for the return surface 104 of the output component shown in FIG. 4A is labeled A. The aperture for the input component can be larger than the aperture or effective aperture for the output component in order to increase the amount of the returning light that is collected in the comparative signals. In some instances, the aperture for the input component is more than 1.2, 1.5, or 2 times the aperture or effective aperture for the output component. In some instances, the aperture for the input component is less than 0.8, 0.6, or 0.5 times the aperture or effective aperture for the output component.

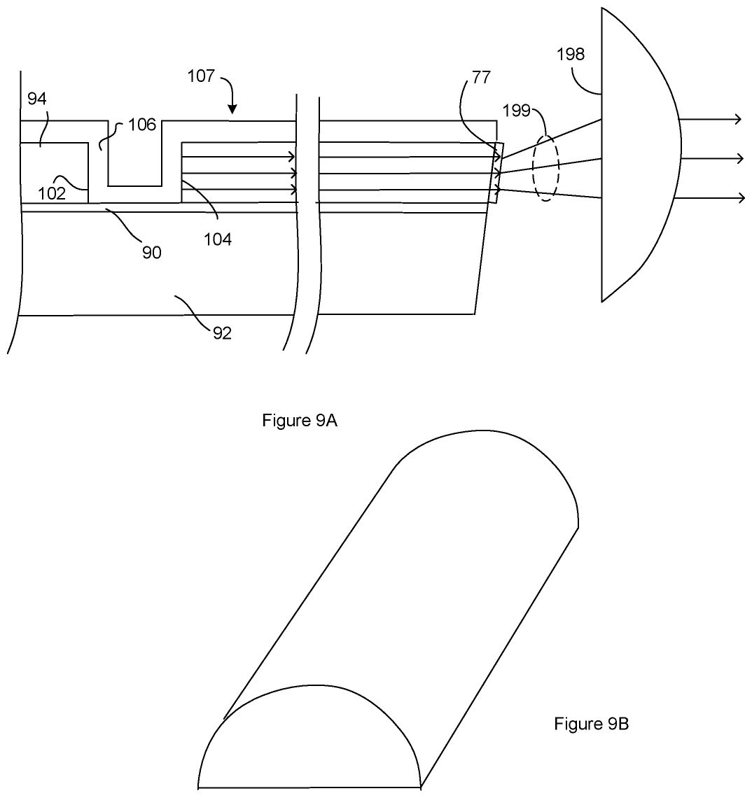

As is evident in images such as FIG. 4A, a return surface 104 can be configured to collimate the outgoing LIDAR signals and/or the LIDAR output signals. However, the collimation can be in a plane that is parallel to a plane of the LIDAR chip as shown in FIG. 4A without providing collimation within a plane perpendicular to the plane of the LIDAR chip. As an example, FIG. 9A is a cross section of a LIDAR chip and a beam shaper 198 that illustrates the interface between the beam shaper 198 and the return surface 104. The return surface 104 and the beam shaper 76 exchange a light signal 199 that is reflected by the return surface and transmitted through the beam shaper 198. Multiple different rays of the light signal 199 are shown in FIG. 9B. The light signal 199 expands vertically upon exiting the LIDAR chip. However, the beam shaper 198 collimates the light signal 199 transmitted through the beam shaper 198. The cross section shown in FIG. 9A can be orthogonal to the plane of the LIDAR chip. As a result, the beam shaper 198 collimates the light signal 199 in a plane that is orthogonal to a plane in which the return surface 104 collimates the light signal. Accordingly, the return surface 104 can collimate the light signal 199 in a first plane that is parallel to a plane of the LIDAR chip without substantially collimating the light signal in a second plane that is orthogonal to the first plane but the beam shaper 198 can provide collimation in the second plane in order to achieve two-dimensional collimation of the light signal 199 after transmission through the beam shaper.

The beam shaper 198 can provide collimation in the second plane without providing substantial collimation within the first plane. For instance, the beam shaper 198 can be a cylindrical lens. A perspective view of an example of a cylindrical lens is illustrated in FIG. 9B. A cylindrical lens is configured to focus collimated light signals into a line rather than the focal point provided by a spherical lens. As a result, a beam shaper 198 can provide collimation in the second plane without providing substantial collimation within the first plane.

In some instances, the function of the beam shaper can be performed with a curved mirror. Accordingly, suitable beam shapers include, but are not limited to, curved mirrors.

The arrows in FIG. 9B indicate that an outgoing LIDAR signal and the resulting LIDAR output signal can serve as the light signal 199 with an output component providing the return surface 104. As a result, the beam shaper 198 shown in FIG. 9A can represent the beam shaper 76 disclosed in the context of FIG. 2. A LIDAR input signal and the resulting incoming LIDAR signal can serve as the light signal 199 with an input component providing the return surface. As a result, the beam shaper 198 shown in FIG. 9A can represent the second beam shaper 80 disclosed in the context of FIG. 2. Accordingly, the interface shown in FIG. 9A can be operated in reverse and the beam shaper 198 can be configured to the light signal 199 in the second plane without substantially focusing the light signal 199 in the first plane and the return surface 104 can be configured to focus the light signal 199 in the first plane without substantially focusing the light signal 199 in the second plane.

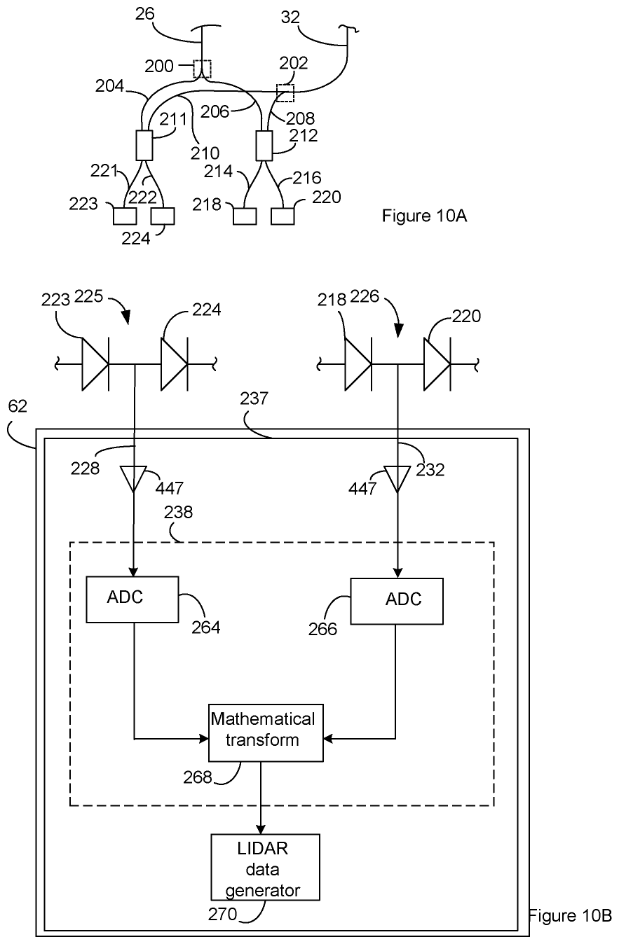

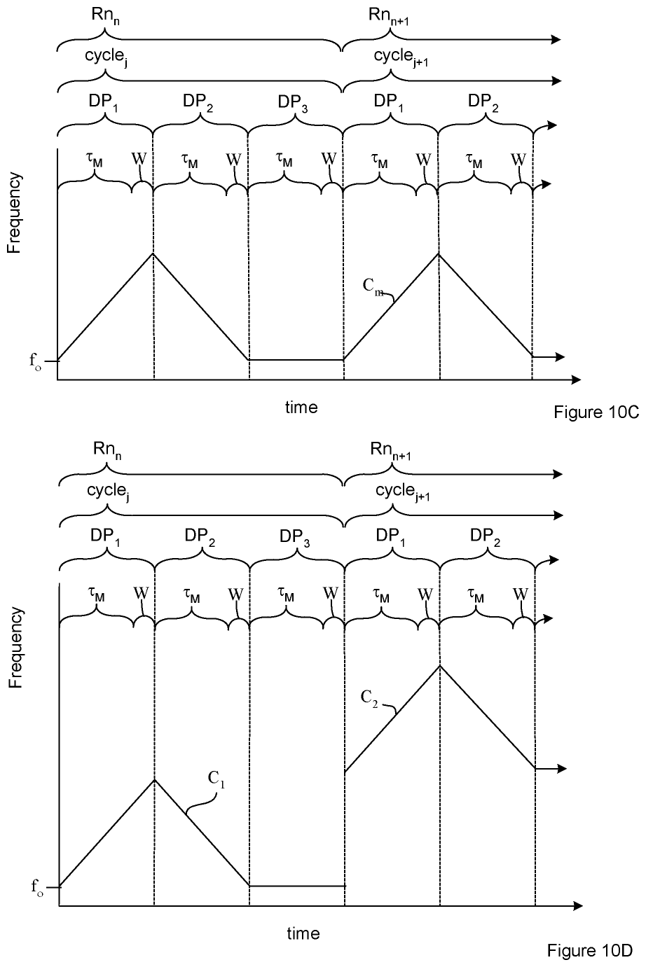

FIG. 10A through FIG. 10B illustrates an example of a light signal processor that is suitable for use as the light signal processor 28. The light signal processor includes an optical-to-electrical assembly configured to convert the light signals to electrical signals. FIG. 10A is a schematic of an example of a suitable optical-to-electrical assembly that includes a first splitter 200 that divides the comparative signal received from a comparative waveguide 26 onto a first comparative waveguide 204 and a second comparative waveguide 206. The first comparative waveguide 204 carries a first portion of the comparative signal to a light combiner 211. The second comparative waveguide 206 carries a second portion of the comparative signal to a second light combiner 212.

The light signal processor of FIG. 10A also includes a second splitter 202 that divides the reference signal received from the reference waveguide 32 onto a first reference waveguide 210 and a second reference waveguide 208. The first reference waveguide 210 carries a first portion of the reference signal to the light combiner 211. The second reference waveguide 208 carries a second portion of the reference signal to the second light combiner 212.

The second light combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal. The first composite signal and the second composite signal are each an example of a composite signal.

The second light combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The light combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light combiner 212 splits the second composite signal such that the portion of the comparative signal in the first portion of the second composite signal is phase shifted by 180° relative to the portion of the comparative signal in the second portion of the second composite signal, the light combiner 211 also splits the composite signal such that the portion of the comparative signal in the first portion of the composite signal is phase shifted by 180° relative to the portion of the comparative signal in the second portion of the composite signal. When the second light combiner 212 splits the second composite signal such that the 76 portion of the reference signal in the first portion of the second composite signal is phase shifted by 180° relative to the portion of the reference signal in the second portion of the second composite signal, the light combiner 211 also splits the composite signal such that the portion of the reference signal in the first portion of the composite signal is phase shifted by 180° relative to the portion of the reference signal in the second portion of the composite signal.

An example of a suitable light combiner 211 and/or a suitable second light combiner 212 is a Multi-Mode Interference (MMI) device such as a 2×2 MMI device. Other suitable light signal combiners include, but are not limited to, adiabatic splitters, and directional couplers. In some instances, the functions of the illustrated light signal combiner 286 are performed by more than one optical component or a combination of optical components.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. The balanced detector(s) serve as light sensors that convert a light signal to an electrical signal. FIG. 10B provides a schematic of the relationship between the electronics 62 and one of the light signal processors 28. For instance, FIG. 10B provides a schematic of the relationship between the electronics 62 and the first light sensor 223, the second light sensor 224, the first auxiliary light sensor 218, and the second auxiliary light sensor 220 from the same light signal processor. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 10B are included on the LIDAR chip. In some instances, the components illustrated in the schematic of FIG. 10B are distributed between the LIDAR chip and electronics located off the LIDAR chip.

The electronics 62 connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data line and the second data line are each an example of a data line. The first data signal is an electrical data signal that carries a representation of the first composite signal and the second data signal is an electrical data signal that carries a representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e., the beating in the first composite signal and in the second composite signal.

The electronics 62 include a data processor 237 configured to generate the LIDAR data. For the purposes of illustration, FIG. 10B illustrates one data processor in the electronics 62, however, the electronics 62 can include a data processor 237 for each light signal processor 28 operated by the electronics 62.

The data processor 237 includes a beat frequency identifier 238 configured to identify the beat frequency of the composite signal from the first data signal and the second data signal. The beat frequency identifier 238 receives the first data signal and the second data signal. Since the first data signal is an in-phase component and the second data signal its quadrature component, the first data signal and the second data signal together act as a complex data signal where the first data signal is the real component and the second data signal is the imaginary component of the complex data signal.

The data processor 237 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The beat frequency identifier 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The beat frequency identifier 238 includes a mathematical transformer 268 that receives the complex data signal. For instance, the mathematical transformer 268 receives the first digital data signal from the first Analog-to-Digital Converter (ADC) 264 as an input and also receives the second digital data signal from the first Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of a comparative signal relative to the system output signal.

The mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The data processor 237 includes a LIDAR data generator 270 that receives the beat frequency of the composite signal from the peak finder. The LIDAR data generator 270 processes the beat frequency of the composite signal so as to generate the LIDAR data (distance and/or radial velocity between the reflecting object and the LIDAR chip or LIDAR system). The transform component 268 can execute the attributed functions using firmware, hardware or software or a combination thereof.

The light source controller 63 operates the light source 10 such that the outbound LIDAR signal and the resulting system output signal have a frequency versus time pattern. For instance, when a light source is constructed according to FIG. 3 and the laser sources include a gain element or laser chip, the light source controller 63 can change the frequency of the outgoing LIDAR signal by changing the level of electrical current applied through the gain element or laser cavity. Additionally, or alternately, the light source 10 can include one or more modulators (not shown) that the light source controller 63 can use to modulate the frequency of the outgoing LIDAR signal. When the light source 10 includes a modulator one or more, the light source controller 63 can operate the modulator so as to achieve the desired frequency versus time pattern in light signals that include light from the outgoing LIDAR signal. The light source controller 63 can execute the attributed functions using firmware, hardware or software or a combination thereof.

FIG. 10C shows an example of a chirp pattern for the outgoing LIDAR signals and the resulting system output signals. FIG. 10C shows an example of a relationship between the frequency of the system output signals, time, cycles, periods and sample regions. The base frequency of a system output signal (fₒ) can be the frequency of the system output signal at the start of a cycle. The frequency versus time pattern shown in FIG. 10C is for system output signals carrying a particular one of the wavelength channels. When the wavelength channel is switched, the system output signals can have the same pattern but at the wavelength of the new wavelength channel. Accordingly, the frequency versus time pattern shown in FIG. 10C will be shifted upward or downward in response to the change in wavelength channel as illustrated in FIG. 10D.

FIG. 10C shows frequency versus time for a sequence of two cycles labeled cycleⱼ and cycleⱼ₊₁. In some instances, the frequency versus time pattern is repeated in each cycle as shown in FIG. 10C. The illustrated cycles do not include re-location periods and/or re-location periods are not located between cycles. As a result, FIG. 10C illustrates the results for a continuous scan where the steering of the system output signal is continuous.

Each cycle includes multiple data periods labeled DP₁, DP₂, and DP₃. In some instances, the frequency versus time pattern is the same for the data periods that correspond to each other in different cycles as is shown in FIG. 10C. Corresponding data periods are data periods with the same period index. As a result, each data period DP₁ can be considered corresponding data periods and the associated frequency versus time patterns are the same in FIG. 10C. At the end of a cycle, the electronics return the frequency to the same frequency level at which it started the previous cycle.

During the data periods DP₁ the electronics operate the light source such that the frequency of the system output signal changes at a linear rate α. During the data periods DP₂ the electronics operate the light source such that the frequency of the system output signal changes at a linear rate −α.

FIG. 10C labels sample regions that are each associated with a sample region index n and are labeled Rnₙ. FIG. 10C labels sample regions Rnₖ and Rnₖ₊₁. Each sample region is illuminated with one of the system output signals during the data periods that FIG. 10C shows as associated with the sample region. For instance, sample region Rnₙ is illuminated with one of the system output signals during the data periods labeled DP₁ through DP₃, however, other sample regions can also be illuminated by one or more other system output signals during the data periods labeled DP₁ through DP₃. The sample region indices n can be assigned relative to time. For instance, the sample regions can be illuminated by the system output signal in the sequence indicated by the index n. As a result, the sample region Rn₁₀ can be illuminated after sample region Rn₉ and before Rn₁₁.

The LIDAR system is typically configured to provide reliable LIDAR data when the object is within an operational distance range from the LIDAR system. The operational distance range can extend from a minimum operational distance to a maximum operational distance. A maximum roundtrip time can be the time required for a system output signal to exit the LIDAR system, travel the maximum operational distance to the object, and to return to the LIDAR system and is labeled τ_{M} in FIG. 10C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a LIDAR beat frequency, the electronics measure the LIDAR beat frequency that results from system return signal that return to the LIDAR system during a data window in the data period. The data window is labeled “W” in FIG. 10C. The contribution from the LIDAR signal to the composite signals will be present at times larger than the maximum operational time delay (τ_{M}). As a result, the data window is shown extending from the maximum operational time delay (τ_{M}) to the end of the data period.

A frequency peak in the output from a mathematical transform such as a Complex Fourier transform represents the beat frequency of the composite signals that each includes a comparative signal beating against a reference signal. The beat frequencies from two or more different data periods can be combined to generate the LIDAR data. For instance, the beat frequency determined from DP₁ in FIG. 10C can be combined with the beat frequency determined from DP₂ in FIG. 10C to determine the LIDAR data. As an example, the following equation applies during a data period where electronics increase the frequency of the outgoing LIDAR signal during the data period such as occurs in data period DP₁ of FIG. 10C: f_{ub}=−f_{d}+ατ where f_{ub} is the frequency provided by the transform component, f_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the chip is assumed to be the positive direction, t is the time in which the light from the system output signal travels to the object and returns to the LIDAR system (the roundtrip time), and c is the speed of light. The following equation applies during a data period where electronics decrease the frequency of the outgoing LIDAR signal such as occurs in data period DP₂ of FIG. 10C: f_{db}=−f_{d}−ατ where f_{db} is a frequency provided by the transform component (f_{i, LDP} determined from DP₂ in this case). In these two equations, f_{d} and τ are unknowns. These two equations can be solved for the two unknowns. The radial velocity for the sample region then be calculated from the Doppler shift (ν=c*f_{d}/(2f_{c})) and/or the separation distance for that sample region can be calculated from c*τ/2. As a result, the electronics use each of the beat frequencies as a variable in one or more equations that yield the LIDAR data. As an example, the distance between the LIDAR system and an object in the sample region (R) can be determiner from Equation 1: R=c(f_{ub}−f_{db})/(2(α_{ub}−α_{db})) where α_{ub} represents the rate of the frequency increase during the data period. Additionally, f_{db} represents the beat frequency during a data period where source controller 63 decreases the frequency of the outgoing LIDAR signal during the data period such as occurs in data period DP₂ from FIG. 10C and α_{db} represents the rate of the frequency decrease during the data period with a decreasing frequency and α_{ub} represents the rate of the frequency decrease during the data period with an increasing frequency. Additionally, the radial velocity between the reflecting object and the LIDAR system (ν) can be calculated Equation 2: ν=λ(α_{db}f_{ub}−α_{ub}f_{db})/(2(α_{ub}−α_{db})). The LIDAR data generator 270 can execute the attributed functions using firmware, hardware or software or a combination thereof.

The data period labeled DP₃ in FIG. 10C is optional. In some situations, there can be more than one object in a sample region. For instance, during the feedback period in DP₁ for cycle₂ and also during the feedback period in DP₂ for cycle₂, more than one frequency pair can be matched. In these circumstances, it may not be clear which frequency peaks from DP₂ corresponds to which frequency peaks from DP₁. As a result, it may be unclear which frequencies need to be used together to generate the LIDAR data for an object in the sample region. As a result, there can be a need to identify corresponding frequencies. The identification of corresponding frequencies can be performed such that the corresponding frequencies are frequencies from the same reflecting object within a sample region. The data period labeled DP₃ can be used to find the corresponding frequencies. LIDAR data can be generated for each pair of corresponding frequencies and is considered and/or processed as the LIDAR data for the different reflecting objects in the sample region.

An example of the identification of corresponding frequencies uses a LIDAR system where the cycles include three data periods (DP₁, DP₂, and DP₃) as shown in FIG. 10C. When there are two objects in a sample region illuminated by the LIDAR outputs signal, the transform component outputs two different frequencies for f_{ub}: fᵤ₁ and fᵤ₂ during DP₁ and another two different frequencies for f_{db}: f_{d1} and f_{d2} during DP₂. In this instance, the possible frequency pairings are: (f_{d1}, fᵤ₁); (f_{d1}, fᵤ₂); (f_{d2}, fᵤ₁); and (f_{d2}, f_{du2}). A value of f_{d} and τ can be calculated for each of the possible frequency pairings. Each pair of values for f_{d} and i can be substituted into f₃=−f_{d}+α₃τ₀ to generate a theoretical f₃ for each of the possible frequency pairings. The value of α₃ is different from the value of a used in DP₁ and DP₂. In FIG. 10C, the value of α₃ is zero. In this case, the transform component also outputs two values for f₃ that are each associated with one of the objects in the sample region. The frequency pair with a theoretical f₃ value closest to each of the actual f₃ values is considered a corresponding pair. LIDAR data can be generated for each of the corresponding pairs as described above and is considered and/or processed as the LIDAR data for a different one of the reflecting objects in the sample region. Each set of corresponding frequencies can be used in the above equations to generate LIDAR data. The generated LIDAR data will be for one of the objects in the sample region. As a result, multiple different LIDAR data values can be generated for a sample region where each of the different LIDAR data values corresponds to a different one of the objects in the sample region.

As noted above, each of the signal processors 28 receives a reference signal associated with waveguide index i and the comparative signal that is associated with the same waveguide index and carrying light in one of the polarization states (C_{i,pi}). Accordingly, the LIDAR data generated for a sample region can be associated with that sample region and one of the polarization states. System output signals are often linearly polarized. For instance, light from a laser source is typically linearly polarized and hence the LIDAR output signal is also typically linearly polarized. Reflection from an object may change the angle of polarization of the returned light. Accordingly, the LIDAR return signal can include light of different linear polarization states. For instance, a first portion of a LIDAR return signal can include light of a first linear polarization state and a second portion of a LIDAR return signal can include light of a second linear polarization state. The first portion of the LIDAR return signal can be included in a first one of the sub-incoming signals while the second portion of the LIDAR return signal can be included in a second one of the sub-incoming signals. In some instances, reflection from an object causes little or no change in the angle of polarization of the reflected light. Alternately, reflection from an object can cause a complete change in the angle of polarization of the reflected light. Accordingly, a first portion of a LIDAR return signal can include light of a first linear polarization state and exclude, or substantially exclude, light of a second linear polarization state, or a first portion of a LIDAR return signal can exclude, or substantially exclude, light of a first linear polarization state and include light of a second linear polarization state.

Since the comparative signals that carry light different sub-incoming signals are received at different signal processors 28, illumination of a single sample region by a system output signal can result in multiple different signal processors 28 that each receives a comparative signal from that sample region. Accordingly, the illumination of a sample region by one of the system output signals can result in LIDAR data being generated for that sample region at multiple different signal processors 28 where each of the LIDAR data results is associated with a different polarization state. Signal processors 28 that generate LIDAR data for the same sample region can be considered associated signal processors 28.

The electronics 62 can include a system processor 290 that has access to the LIDAR data generated by different signal processors 28. When illumination of a sample region by a system output signal results in the generation of LIDAR data for the sample region being generated by multiple different signal processors 28, the system processor 290 can combine the LIDAR data for the sample region from different signal processors 28 so as to calculate the LIDAR data for the sample region. Combining the LIDAR data can include taking an average, median, or mode of the LIDAR data generated at different signal processors 28. For instance, the system processor 290 can calculate the distances between the LIDAR system and the reflecting object in a sample region by averaging the values that associated signals processors 28 generate for the distance between the LIDAR system and the reflecting object in the sample region.

In some instances when illumination of a sample region by a system output signal results in the generation of LIDAR data for the sample region being generated by multiple different signal processors 28, determining the LIDAR data for a sample region includes the system processor 290 identifying one or more composite signals (i.e. the composite signal and/or the second composite signal) received by a group of associated signal processors 28 as the source of the LIDAR data that is most represents reality (the representative LIDAR data). The system processor 290 can then use the LIDAR data from the identified signal processor 28 signal as the representative LIDAR data to be used for additional processing. For instance, the electronics can identify the signal (composite signal) received by a group of associated signal processors 28 with the largest amplitude as having the representative LIDAR data and can use the LIDAR data from the identified signal processors 28 for further processing by the LIDAR system. In some instances, the electronics combine identifying the signal processors 28 with the representative LIDAR data with combining LIDAR data from different signal processors 28. For instance, the electronics can identify associated signal processors 28 that receives a composite signal with an amplitude above an amplitude threshold as having representative LIDAR data and when more than two composite signals are identified as having representative LIDAR data, the electronics can combine the LIDAR data from each of identified signal processors 28. When one of the associated signal processors 28 is identified as having representative LIDAR data, the electronics can use the LIDAR data from that signal processor 28 as the representative LIDAR data. When none of the signal processors 28 is identified as having representative LIDAR data, the electronics can discard the LIDAR data for the sample region associated with those composite signals.

In some instances when illumination of a sample region by a system output signal results in the generation of LIDAR data for the sample region by multiple different signal processors 28, the system processor 290 can generate an indicator of the material from which the reflecting object is constructed. An example of an indicator of the material from which the reflecting object is constructed is a signal level ratio such as a ratio of a signal level of the comparative signal received at a first one of a pair of associated signal processors: a signal level of the comparative signal received at a second one of the pair of associated signal processors. The comparative signal received at the first signal processor can serve as a first comparative signal and the comparative signal received at the second signal processor can serve as a second comparative signal. One example of a suitable signal level ratio is a polarization state power ratio represented by a ratio of the power of the first comparative signal:the power of the second comparative signal. Different object materials cause the system output signal to be reflected at different polarization state power ratios. Accordingly, knowing the polarization state power ratio can indicate what material is being illuminated by the system output signal. When the LIDAR system is used to guide a self-driving vehicle, the ability to distinguish between rain or snow and concrete or metal can be important. The polarization state power ratio can be used in making these sorts of distinctions in self-driving vehicles and other LIDAR applications.

In one example of the LIDAR data generator generating a material indicator that includes or consists of the polarization state power ratio, the LIDAR data generator performs a peak find on the output of the mathematical transformer 268 in the first signal processor to identify a first peak in the beat frequency. The identified peak can be used to remove the ambiguity regarding the correct peak in the output of the mathematical transformer 268 in the second signal processor. For instance, the peak in the output of the mathematical transformer 268 in the second signal processor that occurs closest to the first identified peak frequency can be approximated as the peak that accurately reflects the beat frequency of the beating signals generated by the second signal processor. Accordingly, the LIDAR data generator can perform a peak find on the output of the mathematical transformer 268 in the second signal processor and can find the peak closest to the identified. The peak identified in the output of the mathematical transformer 268 in the second signal processor can serve as a second identified peak. The LIDAR data generator can then determine a ratio of the power of the beat signal at the first identified peak to the power of the beat signal at the second identified peak. The determined ratio can serve as the polarization state power ratio that can be used to identify materials that are illuminated by the system output signal. Suitable peak finders include, but are not limited to, peak analysis mechanisms and peak finding algorithms.

As is evident from FIG. 1A, the LIDAR system can optionally include one or more light signal amplifiers 446. For instance, an amplifier 446 can optionally be positioned along a utility waveguide as illustrated in the LIDAR system of FIG. 1A. Additionally, or alternately, an amplifier 446 can be positioned along all or a portion of the alternate waveguides 16 as illustrated in the LIDAR system of FIG. 1A. The electronics can operate the amplifiers 446 so as to amplify the power of the outgoing LIDAR signal and accordingly of the system output signal. The electronics can operate each of the amplifiers 446 so as to amplify the power of the outgoing LIDAR signal. Suitable amplifiers 446 for use on the LIDAR chip, include, but are not limited to, Semiconductor Optical Amplifiers (SOAs) and SOA arrays. As shown in FIG. 1B, the amplifiers 446 can be arranged in a linear array on an amplifier chip 448.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 62 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of the LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable director controller 15 executes the attributed functions using firmware, hardware, or software or a combination thereof. An example of a suitable light source controller 63 executes the attributed functions using firmware, hardware, or software or a combination thereof. An example of a suitable data processor 237 executes the attributed functions using firmware, hardware, or software or a combination thereof. An example of suitable assembly electronics 290 executes the attributed functions using firmware, hardware, or software or a combination thereof.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as using complex signals such as the complex data signal, the LIDAR system can also use real signals. As a result, the mathematical transform can be a real transform and the components associated with the generation and use of the quadrature components can be removed from the LIDAR system. As a result, the LIDAR system can use a single signal combiner. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A LIDAR system, comprising:
a semiconductor chip configured to concurrently output multiple LIDAR output signals;
the semiconductor chip including alternate waveguides that each carries a different outgoing LIDAR signal, each of the LIDAR output signals including light from a different one of the LIDAR output signals;
the semiconductor chip including a reflecting surface that receives the LIDAR output signals from the alternate waveguides, the reflecting surface being configured such that the LIDAR output signals travel away from the semiconductor chip in different directions.

2. The system of claim 1, wherein the reflecting surface is included in an echelle grating.

3. The system of claim 1, wherein the alternate waveguides each receive a different portion of an outbound LIDAR signal from a splitter, the portion of the outbound LIDAR signal received by each of the alternate waveguides serving as the outgoing LIDAR signal carried by the alternate waveguide.

4. The system of claim 1, further comprising a light source that outputs an outbound LIDAR signal and electronics that operate the light source so as to change a wavelength channel carried by the outbound LIDAR signal, and
each the LIDAR output signals including light from the outbound LIDAR signal.

5. The system of claim 4, wherein a direction that the LIDAR output signals travel away from the LIDAR chip changes in response to the changes in the wavelength channel carried by the outbound LIDAR signal.

6. A LIDAR system, comprising:
a semiconductor chip configured to concurrently output multiple LIDAR output signals;
the semiconductor chip including alternate waveguides that are each configured to carry a different outgoing LIDAR signal, each of the outgoing LIDAR signals including light from a different one of the LIDAR output signals;
the semiconductor chip including a reflecting surface configured to receive and reflect incoming LIDAR signals, each of the incoming LIDAR input signals including light from a different one of the LIDAR output signals; and
the semiconductor chip including comparative waveguides, each of the comparative waveguides configured to receive a comparative signal from the reflecting surface, each of the comparative signal including light from a different one of the incoming LIDAR signals.

7. The system of claim 6, wherein the reflecting surface is included in an echelle grating.

8. The system of claim 6, wherein the alternate waveguides each receive a different portion of an outbound LIDAR signal from a splitter, the portion of the outbound LIDAR signal received by each of the alternate waveguides serving as the outgoing LIDAR signal carried by the alternate waveguide.

9. The system of claim 6, further comprising a light source that outputs an outbound LIDAR signal and electronics that operate the light source so as to change a wavelength channel carried by the outbound LIDAR signal, and
each the LIDAR output signals including light from the outbound LIDAR signal.

10. The system of claim 9, wherein a direction that the LIDAR output signals travel away from the LIDAR chip changes in response to the changes in the wavelength channel carried by the outbound LIDAR signal.

11. The system of claim 6, wherein the semiconductor chip including a second reflecting surface that receives the LIDAR output signals from the alternate waveguides, the second reflecting surface being configured such that the LIDAR output signals travel away from the semiconductor chip in different directions.

12. The system of claim 11, wherein the second reflecting surface is included in an echelle grating.

13. The system of claim 11, wherein the reflecting surface has an aperture and the second reflecting surface has an aperture,
the aperture of the reflecting surface being larger than an effective aperture of the second reflecting surface, the effective aperture of the second reflecting surface being the portion of the aperture of the second reflecting surface through which the second reflecting surface receives the LIDAR output signals.

14. A LIDAR system, comprising:
a semiconductor chip that includes a signal director configured to receive incoming LIDAR signals,
each of the incoming LIDAR signals including light reflected by an object located outside of the LIDAR system,
the signal director configured to direct the incoming LIDAR signals through a free space region of the semiconductor chip such that each of the incoming LIDAR signals separates into multiple sub-incoming LIDAR signals,
the sub-incoming LIDAR signals separated from the same incoming LIDAR signal having different selections of polarization states,
the semiconductor chip including multiple comparative waveguides, each of the comparative waveguides receiving a different one of the sub-incoming LIDAR signals.

15. The LIDAR system of claim 14, wherein the signal director is a diffraction grating.

16. The LIDAR system of claim 14, wherein the signal director is an echelle grating.

17. The LIDAR system of claim 14, wherein a first one of the sub-incoming LIDAR signals separated from a first one of the incoming LIDAR signal has light in a TE polarization state and substantially excludes light in a TM polarization state and a second one of the sub-incoming LIDAR signals separated from the first incoming LIDAR signal has light in the TM polarization state and substantially excludes light in the TE polarization state.

18. The LIDAR system of claim 14, wherein the comparative waveguides each has an entry through which the comparative waveguide receives one of the sub-incoming LIDAR signals, and a center-to-center distance between entries of adjacent comparative waveguide that receive sub-incoming LIDAR signals separated from the same incoming LIDAR signal is greater than 1 μm and 5 μm.

19. The LIDAR system of claim 14, further comprising: electronics configured to operate a light source so as to change a wavelength channel carried by each of the incoming LIDAR signals.

20. The LIDAR system of claim 14, wherein an angle of incidence of each of the incoming LIDAR signals on the signal director changes in response to the change in the wavelength channel carried by each of the incoming LIDAR signals.
